(19) United States
(12) Patent Application Publication
(10) Pub. No.: US 2025/0027213 A1
(43) Pub. Date: Jan. 23, 2025

(54) APPARATUS, SINGLE ELEMENT, AND METHOD FOR WATER ELECTROLYSIS

(71) Applicant: Verdagy, Inc., Moss Landing, CA (US)

(72) Inventors: Thomas H. McWaid, Santa Cruz, CA (US); Shizhao Su, Marina, CA (US); Adrian Basharain, San Leandro, CA (US); Alexander Thomas, Long Beach, CA (US); Jeffrey Donald Olson, Castro Valley, CA (US); Lucas De Caroli, Marina, CA (US)

(21) Appl. No.: 18/774,167

(22) Filed: Jul. 16, 2024

Related U.S. Application Data
(60) Provisional application No. 63/514,164, filed on Jul. 18, 2023.

(51) Int. Cl. C25B 9/77; C25B 9/65; C25B 9/75; C25B 15/00

(52) U.S. Cl. CPC C25B 9/77; C25B 9/65; C25B 9/75; C25B 15/00

(57) ABSTRACT

An apparatus for water electrolysis includes two or more ministacks electrically connected in series and/or in parallel. Each ministack includes a stacked arrangement of 2 to 20 cells that are electrically connected in series. Each cell includes an anode, a cathode, and a separator between the anode and the cathode. Each cell also includes a fluid flow system permitting anode electrolyte to be added to the cell, flowed in contact with the anode, and removed from the cell, and permitting cathode electrolyte to be added to the cell, flowed in contact with the cathode, and removed from the cell. A single element for a water electrolyzer stack includes a cavity formed between a pan and a current collector.

### CROSS-REFERENCE TO RELATED APPLICATION

This application claims the benefit of priority to U.S. Provisional Patent Application Ser. No. 63/514,164 filed Jul. 18, 2023, the disclosure of which is incorporated herein in its entirety by reference.

### BACKGROUND

Alkaline Water Electrolysis (AWE) and Anion Exchange Membrane Water Electrolysis (AEMWE) are used to produce hydrogen and oxygen gases. Both AWE and AEMWE electrolysis cells typically include a cathode separated from an anode by a thin separator. However, conventional methods for AWE and AEMWE suffer from issues such as difficult maintenance, low flowrates of electrolyte, difficulty handing two-phase gas/liquid flow, difficult and complex construction or assembly, difficult and complex sealing, lack of scalability, or a combination thereof.

### SUMMARY OF THE INVENTION

In various aspects, the present invention provides an apparatus for water electrolysis. The apparatus includes two or more ministacks electrically connected in series and/or in parallel. Each ministack includes a stacked arrangement of 2 to 20 cells that are electrically connected in series. Each cell includes an anode, a cathode, a separator between the anode and the cathode, and a fluid flow system permitting anode electrolyte to be added to the cell, flowed in contact with the anode, and removed from the cell, and permitting cathode electrolyte to be added to the cell, flowed in contact with the cathode, and removed from the cell.

In various aspects, the present invention provides a single element for a water electrolyzer stack. The single element includes a pan, a current collector parallel to the pan, and a gap between the pan and the current collector. The single element includes one or more electrically conductive connectors between the pan and the current collector that physically connect the pan and the current collector. The single element includes an inlet that allows electrolyte to flow into the gap and into contact with an electrode adjacent to a face of the current collector that faces away from the pan, and an outlet to allow electrolyte to flow out of the gap. The inlet and the outlet are independently located at one or more edges of the single element, and wherein the pan and the current collector together form a cavity therebetween.

In various aspects, the present invention provides an apparatus for water electrolysis. The apparatus includes a stack including a stacked arrangement of two or more of the single element of the present disclosure that are electrically connected in series.

In various aspects, the present invention provides a method of performing water electrolysis. The method includes electrolyzing water using the apparatus for water electrolysis of the present disclosure.

In various aspects, the present invention provides a method of manipulation and/or leak testing of a ministack as described herein. The method includes using tie rods and backing plates to provide sufficient compression of the apparatus to operate the cells at a pressure of 0.25 to 2 psig.

In various aspects, the present invention provides a method of performing water electrolysis using the apparatus for water electrolysis of the present disclosure. The method includes using an electrolyzer frame to provide compression to the apparatus sufficient to operate the cells at a pressure of 2 psig to 450 psig, or 2 psig to 100 psig.

In various aspects, the apparatus, single element, and method for water electrolysis of the present invention has various advantages over other apparatus and methods for water electrolysis. For example, as compared to conventional methods for electrolyzing water, the method, single element, or apparatus of the present disclosure can be easier to maintain, have higher electrolyte flowrates, achieve higher gas flowrates in two-phase flow, be easier and less complex to construct or assemble, be easier and less complex to seal, be more easily and less expensively scaled to large or small sizes, or a combination thereof.

### BRIEF DESCRIPTION OF THE FIGURES

The drawings illustrate generally, by way of example, but not by way of limitation, various aspects of the present invention.

FIG. 1 illustrates an image that depicts a typical filter press for anionic water electrolysis.

FIG. 2 illustrates a photograph of a single element cell being loaded into a electrolyzer, in accordance with various aspects.

FIG. 3 illustrates a photograph of a bipolar plate.

FIG. 4 illustrates a six-cell stack, in accordance with various aspects.

FIG. 5 illustrates an image of one of the cells from the six-cell stack shown in FIG. 4, in accordance with various aspects.

FIG. 6 illustrates a top section of two half cells, in accordance with various aspects.

FIG. 7 illustrates two half-cells having walls attached thereto, in accordance with various aspects.

FIG. 8 illustrates an image depicting ganged inlets and outlets of adjacent cells, in accordance with various aspects.

FIG. 9 illustrates a bipolar pan, in accordance with various aspects.

FIG. 10 illustrates a pan with pan walls that include electrolyte channels, in accordance with various aspects.

FIG. 11 illustrates a pan with pan walls that include electrolyte channels, in accordance with various aspects.

FIG. 12 illustrates a stack including pan walls that include electrolyte channels and including internal manifolding, in accordance with various aspects.

FIG. 13A illustrates an angular front view of a stack including pan walls that include electrolyte channels and including external manifolding, in accordance with various aspects.

FIG. 13B illustrates a top view of a stack including pan walls that include electrolyte channels and including external manifolding, in accordance with various aspects.

FIG. 14 illustrates a cell, a ministack including a plurality of cells, a stack including a plurality of the ministacks, and an alternative stack including a plurality of ministacks, in accordance with various aspects.

FIG. 15 illustrates a frame for compressing one or more ministacks, in accordance with various aspects.

FIG. 16 illustrates a frame for compressing one or more ministacks, in accordance with various embodiments.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Apparatus for Water Electrolysis Including Two or More Ministacks.

Various aspects of the present invention provide an apparatus for water electrolysis. The apparatus can include two or more ministacks that are electrically connected to one another in series and/or in parallel. The apparatus can include 2 to 200 ministacks, or 2 to 100, or 2 to 50, or less than or equal to 200 and greater than or equal to 2 and less than, equal to, or greater than 3, 4, 6, 8, 10, 15, 20, 30, 40, 50, 100, or 150 ministacks. Each ministack can include a stacked arrangement of 2 to 20 cells that are electrically connected in series. Each cell can include an anode, a cathode, and a separator between the anode and the cathode. Each cell can include a fluid flow system permitting anode electrolyte to be added to the cell, flowed in contact with the anode, and removed from the cell. The fluid flow system can also permit cathode electrolyte to be added to the cell, flowed in contact with the cathode, and removed from the cell.

The water electrolysis method of the apparatus can be described as advanced alkaline water hydrolysis. The membrane separator used can be any appropriate type of membrane, such as an ion exchange membrane (e.g., anion exchange membrane (AEM) or cation exchange membrane (CEM)), a diaphragm, a nanoporous separator, an ion solvating membrane, and the like. The separator can be coated with a catalyst on one or both surfaces, or not coated on either surface. In some examples, the water electrolysis provided by the apparatus can be alkaline water electrolysis (AWE) and anion exchange membrane water electrolysis (AEMWE).

Each ministack can include 2 to 20 of the cells, or 3 to 10 of the cells, or less than or equal to 20 of the cells and greater than or equal to 2 of the cells and less than, equal to, or greater than 3, 4, 5, 6, 7, 8, 9, 10, 11, 12, 13, 14, 15, 16, 17, 18, or 19 of the cells. Each ministack including the stacked arrangement of the cells therein can be physically bundled together as an independent assembly that can be manipulated (e.g., moved, serviced, and the like) independently of the one or more other ministacks in the apparatus.

The two or more ministacks can be electrically connected in series. The two or more ministacks can be electrically connected in parallel. Two or more of the ministacks can be electrically connected in series, and another two or more of the ministacks can be electrically connected in parallel. Any suitable combination of series and parallel connections can be used.

The fluid flow systems of the cells in a single one of the ministacks can be connected to one another in parallel. For example, the fluid flow systems of the cells the ministack can be connected in parallel such that each cell receives fresh electrolyte.

The anode electrolyte and the cathode electrolyte can be any electrolyte solution that is suitable for advanced alkaline water electrolysis. For example, the anode electrolyte and the cathode electrolyte can independently include an aqueous solution including a base. The base can be any suitable base, such as NaOH, KOH, or a combination thereof. The anode electrolyte and the cathode electrolyte can independently have a concentration of NaOH and/or KOH of 0 M to 10 M, or 0.1 M to 9 M, or less than or equal to 10 M and greater than or equal to 0 M and less than, equal to, or greater than 0.1 M, 0.5, 1, 1.5, 2, 2.5, 3, 3.5, 4, 4.5, 5, 5.5, 6, 6.5, 7, 7.5, 8, 8.5, 9, or 9.5 M.

The anode and the cathode can be formed any materials suitable for electrodes for advanced alkaline water electrolysis. For example, the anode and the cathode can independently include an electrode material such as Ni, stainless steel, carbon, carbon steel, titanium, platinum, or a combination thereof. The anode or cathode can be made of the electrode material, or the anode or cathode can include a base material with a coating of the electrode material thereon, with the base material including a suitable material such as stainless-steel or carbon steel. In various aspects, the anode and/or cathode can be free of an electrocatalyst. In other embodiments, the anode and/or cathode include an electrocatalyst that is suitable for catalyzing the electrolysis of water, such as an electrocatalyst including a platinum group metal (e.g., Ru, Pt, Ir), nickel, iron, cobalt, manganese, copper, or a combination thereof. The electrocatalyst can optionally be present on a support (e.g., as a coating or deposition), such as a support including Ni, stainless steel, carbon, carbon steel, titanium, platinum, or a combination thereof. The anode and/or cathode can be a coating on the anode or cathode current collector, or the anode and/or cathode can be a separate component from the current collector. The anode and/or cathode can be a porous material that is adjacent to the current collector, such as a metal mesh, a woven metal mesh, or a metal foam.

The ministack can further include two backing plates that sandwich the two or more cells in the ministack. The backing plates can apply inward pressure on the stack to maintain seals and physical and electrical contact within the stack. The backing plates can include nickel, copper, stainless steel, carbon steel, titanium, or stainless steel or titanium coated with nickel. The backing plates can optionally include a plating or deposition of a material that decreases electrically contact resistance between it and the plate belonging to a neighboring ministack and/or between it and a first in-board cell, wherein the material can include nickel, silver, gold, platinum, and the like. The ministack can further include one or more tie rods that physically connect the backing plates to each other. The one or more tie rods can be used to cause the backing plates to apply pressure to the stack.

The ministack can further include one or more seals between the anode and the separator, the separator and the cathode, or a combination thereof. The one or more seals can be any suitable seal, such as including a gasket, an o-ring, a face gasket, gasket tape, or a molded edge seal.

The cell can further include a cathode current collector. The cathode current collector and the separator can be adjacent to the cathode and sandwich the cathode. The cell can further include an anode current collector. The anode current collector and the separator can be adjacent to the anode and sandwich the anode. The anode and cathode current collectors can be porous, such as a metal foam, a compressed woven metal mesh, a woven metal mesh, or a sheet of expanded metal. In various aspects, the cathode is a coating on a cathode current collector, and/or the anode is a coating on an anode current collector. For example, the anode or cathode can be a coating on a current collector, such as on a metal foam, a compressed woven metal mesh, a woven metal mesh, or a sheet of expanded metal. In various aspects, the cathode is a separate component from the cathode current collector and/or the anode is a separate component from the anode current collector.

The anode, the cathode, and the separator can have any suitable shape. The anode, the cathode, and the separator can be planar. The anode, the cathode, and the separator can have a perimetric profile of a square, a rectangle, a circle, an oval, or a polygon. The ministack can have an external profile that is consistent with the perimetric profile of the anode, the cathode, and the separator of the cells in the stack. The ministack can have an external profile of a disc, a cylinder, an oval cylinder, a cuboid, or a rectangular cuboid.

The apparatus can be for advanced alkaline water electrolysis, such as alkaline water electrolysis or anion exchange membrane water hydrolysis.

The apparatus can be for alkaline water electrolysis. The anode electrolyte and the cathode electrolyte can be aqueous solutions that independently have a concentration of NaOH and/or KOH of 3 M to 10 M (e.g., 4 M to 8 M, or less than or equal to 10 M and greater than or equal to 3 M and less than, equal to, or greater than 4 M, 5, 6, 7, 8, or 9 M). The separator can be a membrane that is conductive to ions and that is substantially non-conductive to electricity, oxygen gas, and hydrogen gas. The membrane can be selectively or non-selectively permeable to ions and can be permeable to OH ions. The separator can be porous, such as a porous diaphragm. The separator can include PSU/ZrO₂, alkaline-stable hexyltrimethyl ammonium-functionalized Diels-Alder poly(phenylene) (HTMA-DAPP), quaternized polycabozole-trimethyl amine (QPC-TMA), poly(2,2′-(m-phenylene)-5,5-bibenzimidazole) (m-PBI), poly(fluorenyl-co-terphenyl piperidinium) (PFTP), poly(fluorenyl-co-aryl piperidinium) (PFAP), or a combination thereof.

The apparatus can be for anion exchange membrane water hydrolysis. The separator can include an anion exchange membrane that is conductive to OH ions and is substantially non-conductive to electricity, oxygen, and hydrogen. The anion exchange membrane includes a polymer including a poly(arylene ether)-based backbone, polyolefin-based backbone, polyphenylene-based backbone, a backbone containing a cationic moiety, or a combination thereof. The anion exchange membrane can be based on alkaline-stable hexyltrimethyl ammonium-functionalized Diels-Alder poly(phenylene) (HTMA-DAPP), quaternized polycabozole-trimethyl amine (QPC-TMA), poly(2,2′-(m-phenylene)-5,5-bibenzimidazole) (m-PBI), poly(fluorenyl-co-terphenyl piperidinium) (PFTP), poly(fluorenyl-co-aryl piperidinium) (PFAP), or a combination thereof.

The ministack can be a filter press design, such as wherein the electrolyte flows through internal channels without exiting the ministack as it passes through the cells. The internal channels can be located outside of the active areas of the cells. The manifold passages and associated seals of the internal channels can be features of the plates/pans used to construct the ministack. In an example, four manifolded flows can occur per stack (e.g., anode inlet, anode outlet, cathode inlet, cathode outlet). The ministack can include one or more anode electrolyte channels between and within the cells of the ministack, and one or more cathode electrolyte channels between and within the cells of the ministack. The fluid flow system of the cell can flow anode electrolyte from an internal manifold located outside of the ministack's active area to each of the cells in the ministack in a parallel fashion through one or more anode electrolyte channels between an anode inlet manifold and the various cells of the ministack and/or flow cathode electrolyte in parallel to each cell through one or more cathode electrolyte channels between a cathode inlet manifold and the various cells of the ministack. The fluid flow system can accept anode electrolyte into an internal manifold located outside of the ministack's active area from each of the cells in the ministack in a parallel fashion through one or more anode electrolyte channels between an anode outlet manifold and the various cells of the ministack and/or flow cathode electrolyte in parallel to each cell through one or more cathode electrolyte channels between a cathode outlet manifold and the various cells of the ministack.

In various aspects, the ministack is a stack of single elements, wherein each single element can include a pan, a current collector parallel to the pan, and a gap between the pan and the current collector. The single element can include one or more electrically conductive connectors between the pan and the current collector that physically connect the pan and the current collector. The single element can include an inlet (e.g., one or more inlets) that allows electrolyte to flow into the gap and into contact with an electrode adjacent to a face of the current collector that faces away from the pan, and an outlet (e.g., one or more outlets) to allow electrolyte to flow out of the gap. The inlet and the outlet can be independently located at one or more edges of the single element. The pan and the current collector together can form a cavity therebetween.

The ministack can include the separators of the cells of the ministack between the single elements. If the single elements do not include an electrode, the separators of the cells sandwiched by an anode and a cathode can be included between the single elements of the ministack. Within the ministack, the pan and current collector can be compressed against the electrode and separator, with optional seals placed around a perimeter of the pan and current collector, such that a volume between the pan and the separator is sealed such that liquids and gases are substantially sealed in the volume other than the one or more inlets and outlets.

The pan can be formed of any suitable material. The pan can be an electrically conductive pan (e.g., formed of metal such as nickel or stainless-steel), such that the one or more conductive connectors (e.g., current ribs) that physically connect the current collector and the pan provides an electrical connection between the current collector and the pan. In various aspects, the one or more conductive connectors can be welded to the pan. The one or more conductive connectors can be welded to an electrode or to a current collector (e.g., to the first or second current collectors). The one or more conductive connectors can be attached to the first or second current collectors via a connector such as clips. The connector or clips can be welded to the current collector, or the connector/clips can be removable from the current collector. The connector/clips can provide a low resistance electrical connection between the conductive connector and the current collector.

The pan can be an electrically non-conductive pan (e.g., formed of plastic, or formed of a relatively electrically non-conductive material coated with an electrically non-conductive material), or a pan with relatively low electrical conductivity (e.g., stainless steel), such that the conductive connector that physically connects the current collector and the pan provides an electrical connection between the current collector and a conductive material other than the pan (e.g., the conductive connector can protrude slightly outside the pan floor so as to enable direct contact to a conductive connector of an adjacent cell). In such a case, the electrical current would not flow through the pan floor, but rather through the series of conductive connectors. The conductive connectors can be sealed to the pan floor such that liquid electrolyte does not leak through the areas of the pan where they pass through, such as via welding, adhesive, brazing, and the like. In various aspects, the conductive connectors can pass through the pan and be welded to the pan. For example, the conductive connectors can pass through a stainless-steel pan and the pan floor can be welded to the conductive connectors such that they are sealed thereto.

The single element can be free of electrodes; in such aspects, during use the conductive connector of the single element can be contacted with an electrode (e.g., an anode or a cathode). The single element and the electrode that electrolyte can flow into contact with can be free of physical attachment therebetween (e.g., can be removably contacted). In other aspects, the single element includes a physical attachment (e.g., a weld, adhesion, fasteners, or other connection) to an electrode, or the electrode is a coating on the current collector. For example, the single element can include a cathode of a cell with a physical attachment to the current collector, or the single element can include an anode of a cell with a physical attachment to the current collector.

In one or both half-cells, an electrode (i.e., anode or cathode) can be wrapped around the edges of a respective current collector (e.g., such that one major side of the current collector is relatively free of the electrode while the other major side of the current collector is completely covered by the electrode), clipped against a current collector, welded to a current collector, or an electrode can be a coating on the current collector. In various aspects, the single element can include an elastic element (e.g., one or more elastic elements, such as 1, 2, 3, 4, or more) between the electrode and the current collector. For example, an electrode can be wrapped around the edges of a current collector with an elastic element sandwiched between the electrode and the current collector, or an electrode can be clipped or otherwise attached to the current collector with an elastic element sandwiched therebetween. The elastic element can be any suitable elastic element that generates a load of 1 to 5 psig when compressed in the range of 1 to 5 mm. The elastic element can be a nickel mesh or nickel foam. The elastic element can be a nickel-coated structure fabricated from carbon steel or other metal, or from a polymer. The elastic element can have low contact resistance, high electrical conductivity, and high porosity. In various aspects, the elastic element can be an elastic layer. The elastic element can be compressed in a stack including the single element to provide a zero gap architecture with the electrodes loaded against the separator.

In various aspects, the single element can be free of additional current collectors that are physically connected to the pan via conductive connectors. In various aspects, the single element can be free of additional current collectors (e.g., the single element can include only the single current collector). Such single elements free of additional current collectors can be a half-cell (e.g., an anode half-cell or a cathode half-cell).

In various aspects, the current collector can be a first current collector, the one or more electrically conductive connectors are one or more first electrically conductive connectors, the inlet and outlet are a first inlet and a first outlet, the cavity is a first cavity, and the gap is a first gap. On an opposite face of the pan the single element can further include a second current collector parallel to the pan, a second gap between the second current collector and the pan, and one or more second electrically conductive connectors between the pan and the second current collector that physically connect the pan and the second current collector. On the opposite face of the pan the single element can further include a second inlet (e.g., one or more second inlets) that allows electrolyte to flow into the second gap and into contact with an electrode adjacent to a face of the second current collector that faces away from the pan, and a second outlet (e.g., one or more second outlets) that allows electrolyte to flow out of the second gap. The inlet and the outlet can be independently located at one or more edges of the single element. The pan and the current collector can together form a second cavity therebetween. The apparatus can include the anode of a cell adjacent to the first current collector (e.g., on a face of the first current collector that faces away from the pan) and the cathode of a cell adjacent to the second current collector (e.g., on a face of the second current collector that faces away from the pan), or can include the cathode of a cell adjacent to the first current collector and the anode of a cell adjacent to the second current collector. The anode and cathode can be physically connected to the current collectors or can be free of physical connection and merely held together via compression and optionally via interlocking features. The pan can be electrically conductive and can be connected to the first and second current collectors via the first and second electrically conductive connectors. In an alternative aspect, the pan is electrically non-conductive, and the conductive connectors pass through the pan (e.g., they are single conductive connectors passing through the pan instead of first and second conductive connectors on either side of the pan) to provide an electrical connection between the first current collector and the second current collector.

The conductive connector can be any suitable conductive member that can be attached to the current collector and the pan and that is electrically conductive. The conductive connector can be metallic. The conductive connector can include Ni, stainless steel, carbon, carbon steel, titanium, or a combination thereof. The conductive connector can have any suitable physical form, such as a wire, a bar, a strut, a rib, a rib plate, or a combination thereof. The conductive connector can be a rib or rib plate.

The single element can further include one or more seals around a perimeter of the pan and the current collector. The seals can be placed around the perimeter of the pan and current collector. The seals can occur between the separator and the pan. The seals can be any suitable seals, such as a gasket, an o-ring, a face gasket, gasket tape, or a molded edge seal.

The pan can include a flange at an edge thereof, such that the flange on the pan and the flange on the pan of an adjacent single element can come together to form a seal with one another. The flanges can seal with direct contact therebetween, or a seal can be placed between the flanges, such as a gasket, an o-ring, a face gasket, gasket tape, or a molded edge seal. The flange can include fastener holes, or the flange can be free of fastener holes.

The one or more inlets of the single element can be configured such that they sealingly align and fluidly connect with the one or more inlets of another one of the single element adjacent thereto. The one or more outlets of the single elements can be configured such that they sealingly align and fluidly connect with the one or more outlets of another one of the single element adjacent thereto.

The pan can be a single continuous sheet with bent sides forming edges. The bent sides can have a thickness identical to a thickness of a bottom of the pan. For example, such a pan can be formed from a single sheet and can have an advantage of simplistic and efficient fabrication. The bent sides can have a thickness that exceeds a thickness of a bottom of the pan; such a pan can be formed by adding thicker edges to the pan bottom.

The pan can be a flat sheet and the single element can further include sides (e.g., sidewalls) that are physically connected to the pan. The sides can be formed from rods or beams, such as hollow cylindrical rods, hollow rectangular beams, solid cylindrical rods, solid rectangular beams, or custom extrusions. In various aspects, custom extrusions can be utilized with features allowing facile placement of sealing elements, such as o-ring grooves.

The pan can include sides formed from hollow rods or beams (e.g., hollow rectangular beams), and the sides can include an anode electrolyte channel and/or a cathode electrolyte channel. For example, the top of the pan can include a side that is a hollow beam that is an outlet header for electrolyte and that includes orifices facing an electrolyte chamber that allows electrolyte to flow therein. The bottom of the pan can include a side that is a hollow beam that is an inlet header for electrolyte and that includes orifices facing an electrolyte chamber that allows electrolyte to flow from the hollow beam into the electrolyte chamber. The ministack can include internal manifolding of cathode and/or anode electrolyte streams, such as via openings or pass-throughs in the hollow rod or beam that provide manifolding of cathode and/or anode electrolyte streams without combining the cathode electrolyte with the anode electrolyte. The ministack can include external manifolding of cathode and/or anode electrolyte streams that combines the individual cathode and/or anode electrolyte streams externally while preventing mixing of the cathode electrolyte with the anode electrolyte.

The single element can have any suitable thickness. The single element can have a substantially uniform thickness throughout to facilitate stacking of the single element. The single element can have a thickness of 10 mm to 150 mm, or 30 mm to 65 mm, or less than or equal to 150 mm and greater than or equal to 10 mm and less than, equal to, or greater than 15, 20, 25 mm, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 70, 75, 80, 85, 90, 95, 100, 110, 120, 130, or 140 mm.

### Single Element for a Water Electrolyzer Stack.

Various aspects of the present invention provide a single element for a water electrolyzer stack. The single element is a modular component of a water electrolyzer stack that avoids electrolyte flow cell to cell within the stack, enabling higher flow rates, and enabling non-series flow of electrolyte (e.g., which can provide fresh electrolyte to each single element). The single element can include a pan, a current collector parallel to the pan, and a gap between the pan and the current collector. The single element can include one or more electrically conductive connectors between the pan and the current collector that physically connect the pan and the current collector. The single element can include an inlet (e.g., one or more inlets) that allows electrolyte to flow into the gap and into contact with an electrode adjacent to a face of the current collector that faces away from the pan. The single element can include an outlet (e.g., one or more outlets) to allow electrolyte to flow out of the gap. The inlet and the outlet can be independently located at one or more edges of the single element. The pan and the current collector together can form a cavity therebetween.

In various aspects, the single element can be free of an electrode, such that the single element is free of any physical attachment to a cathode or anode. Such a single element can be placed adjacent to an electrode during use. In other aspects, the single element includes one or more electrodes. For example, in some aspects, the single element includes a cathode or an anode physically connected to the current collector (i.e., on a face of the current collector that faces away from the pan). In various aspects, the single element is a weldment and the electrodes are folded over and/or clipped into place against the current collectors prior to assembly of the cell. Within an electrode stack including the single element, the pan and current collector can be compressed against the electrode and separator, with optional seals placed around a perimeter of the pan and current collector, such that a volume between the pan and the separator is sealed such that liquids and gases are substantially sealed in the volume other than the one or more inlets and outlets.

In one or both half-cells, an electrode (i.e., anode or cathode) can be wrapped around the edges of a respective current collector (e.g., such that one major side of the current collector is relatively free of the electrode while the other major side of the current collector is completely covered by the electrode), clipped against a current collector, welded to a current collector, or an electrode can be a coating on the current collector. In various aspects, the single element can include an elastic element (e.g., one or more elastic elements, such as 1, 2, 3, or 4 or more) between the electrode and the current collector. For example, an electrode can be wrapped around the edges of a current collector with an elastic element sandwiched between the electrode and the current collector, or an electrode can be clipped or otherwise attached to the current collector with an elastic element sandwiched therebetween. The elastic element can be any suitable elastic element that produces a load of about 1 to 5 psig when compressed in the range of 1 to 5 mm. The elastic element can be a nickel mesh or nickel foam. The elastic element can be a nickel-coated structure fabricated from carbon steel or other metal, or from a polymer. The elastic element can have low contact resistance, high electrical conductivity, and high porosity. In various aspects, the elastic element can be an elastic layer. The elastic element can be compressed in a stack including the single element to provide a zero gap architecture with the electrodes loaded against the separator.

The pan can be formed of any suitable material. The pan can be an electrically conductive pan (e.g., formed of metal such as nickel or stainless-steel), such that the one or more conductive connectors (e.g., current ribs) that physically connect the current collector and the pan provides an electrical connection between the current collector and the pan. The pan can be an electrically non-conductive pan (e.g., formed of plastic, or formed of a relatively electrically non-conductive material coated with an electrically non-conductive material), or a pan with relatively low electrical conductivity (e.g., stainless steel), such that the conductive connector that physically connects the current collector and the pan provides an electrical connection between the current collector and a conductive material other than the pan (e.g., the conductive connector can protrude slightly outside the pan floor so as to enable direct contact to a conductive connector of an adjacent cell. In such a case, the electrical current would not flow through the pan floor, but rather through the series of conductive connectors. The conductive connectors can be sealed to the pan floor such that liquid electrolyte does not leak through the areas of the pan where they pass through, such as via welding, adhesive, brazing, and the like. In various aspects, the conductive connectors can pass through the pan and be welded to the pan. For example, the conductive connectors can pass through a stainless steel pan and the pan floor can be welded to the conductive connectors such that they are sealed thereto.

In various aspects, the single element is free of additional current collectors that are physically connected to the pan. In various aspects, the single element can be free of additional current collectors (e.g., the single element can include only the single current collector). Such single elements free of additional current collectors can be a half-cell (e.g., an anode half-cell or a cathode half-cell).

In various aspects, the current collector can be a first current collector, the one or more electrically conductive connectors are one or more first electrically conductive connectors, the inlet and outlet are a first inlet and a first outlet, the cavity is a first cavity, and the gap is a first gap. On an opposite face of the pan the single element can further include a second current collector parallel to the pan, a second gap between the second current collector and the pan, and one or more second electrically conductive connectors between the pan and the second current collector that physically connect the pan and the second current collector. On the opposite face of the pan the single element can further include a second inlet (e.g., one or more second inlets) that allows electrolyte to flow into the second gap and into contact with an electrode adjacent to a face of the second current collector that faces away from the pan, and a second outlet (e.g., one or more second outlets) that allows electrolyte to flow out of the second gap. The inlet and the outlet can be independently located at one or more edges of the single element. The pan and the current collector can together form a second cavity therebetween. In various aspects, the first and second current collector can be free of physical attachment to an electrode. In such aspects, the first and second current collector can be adjacent to electrodes during use. In other aspects, the single element includes one or more electrodes. For example, in some aspects, the first current collector includes a cathode or an anode physically connected thereto (i.e., on a face of the first current collector that faces away from the pan), and the second current collector includes a cathode or an anode physically connected thereto (i.e., on a face of the second current collector that faces away from the pan). The pan can be electrically conductive and can be connected to the first and second current collectors via the first and second electrically conductive connectors. The electrically conductive connectors can terminate at the pan and the pan can be free of penetration by the electrically conductive connector. In an alternative aspect, the pan is electrically non-conductive, and the conductive connectors pass through the pan (e.g., they are single conductive connectors passing through the pan instead of first and second conductive connectors on either side of the pan) to provide an electrical connection between the first current collector and the second current collector.

The conductive connector can be any suitable conductive member that can be attached to the current collector and the pan and that is electrically conductive. The conductive connector can be metallic. The conductive connector can include Ni, stainless steel, carbon, carbon steel, titanium, platinum, or a combination thereof. The conductive connector can have any suitable physical form, such as a wire, a bar, a strut, a rib, a rib plate, or a combination thereof. The conductive connector can be a rib or rib plate. In various aspects, the conductive connector can be welded to the pan. The conductive connector can be welded to an electrode or to a current collector. The conductive connector can be attached to the current collector via a connector such as clips. The connector or clips can be welded to the current collector, or the connector/clips can be removable from the current collector. The connector/clips can provide a low resistance electrical connection between the conductive connector and the current collector.

The single element can further include one or more seals around a perimeter of the pan and the current collector. The seals can be any suitable seals, such as a gasket, an o-ring, a face gasket, gasket tape, or a molded edge seal.

The pan can include a flange at an edge thereof, such that the flange on the pan and the flange on the pan of an adjacent single element can come together to form a seal with one another. The flanges can seal with direct contact therebetween, or a seal can be placed between or around the flanges, such as a gasket, an o-ring, a face gasket, gasket tape, or a molded edge seal. The flange can include fastener holes, or the flange can be free of fastener holes.

The one or more inlets of the single element can be configured such that they sealingly align and fluidly connect with the one or more inlets of another one of the single element adjacent thereto. The one or more outlets of the single elements can be configured such that they sealingly align and fluidly connect with the one or more outlets of another one of the single element adjacent thereto.

The pan can be a single continuous sheet with bent sides forming edges. The bent sides can have a thickness identical to a thickness of a bottom of the pan. For example, such a pan can be formed from a single sheet and can have an advantage of simplistic and efficient fabrication. The bent sides can have a thickness that exceeds a thickness of a bottom of the pan; such a pan can be formed by adding thicker edges to the pan bottom.

The pan can be a flat sheet and the single element can further include sides (e.g., sidewalls) that are physically connected to the pan. The sides can be formed from rods or beams, such as hollow cylindrical rods, hollow rectangular beams, solid cylindrical rods, or solid rectangular beams.

The pan can include sides formed from hollow rods or beams (e.g., hollow rectangular beams), and the sides can include an anode electrolyte channel and/or a cathode electrolyte channel. For example, the top of the pan can include a side that is a hollow beam that is an outlet header for electrolyte and that includes orifices facing an electrolyte chamber that allows electrolyte to flow therein. The bottom of the pan can include a side that is a hollow beam that is an inlet header for electrolyte and that includes orifices facing an electrolyte chamber that allows electrolyte to flow from the hollow beam into the electrolyte chamber. A ministack including a plurality of the single elements can include internal manifolding of cathode and/or anode electrolyte streams, such as via openings or pass-throughs in the hollow rod or beam that provide manifolding of cathode and/or anode electrolyte streams without combining the cathode electrolyte with the anode electrolyte. A ministack including a plurality of the single elements can include external manifolding of cathode and/or anode electrolyte streams that combines the individual cathode and/or anode electrolyte streams externally while preventing mixing of the cathode electrolyte with the anode electrolyte.

The single element can have any suitable thickness. The single element can have a substantially uniform thickness throughout to facilitate stacking of the single element. The single element can have a thickness of 20 mm to 150 mm, or 30 mm to 65 mm, or less than or equal to 150 mm and greater than or equal to 20 mm and less than, equal to, or greater than 25 mm, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 70, 75, 80, 85, 90, 95, 100, 110, 120, 130, or 140 mm.

### Apparatus for Water Electrolysis Including Two or More Single Elements.

Various aspects of the present invention provide an apparatus for water electrolysis that includes a stack that includes a stacked arrangement of two or more of the single elements described herein. The single element can include a pan, a current collector parallel to the pan, and a gap between the pan and the current collector. The single element can include one or more electrically conductive connectors between the pan and the current collector that physically connect the pan and the current collector. The single element can include an inlet (e.g., one or more inlets) that allows electrolyte to flow into the gap and into contact with an electrode adjacent to a face of the current collector that faces away from the pan. The single element can include an outlet (e.g., one or more outlets) to allow electrolyte to flow out of the gap. The inlet and the outlet can be independently located at one or more edges of the single element. The pan and the current collector together can form a cavity therebetween. In various aspects, the single element can be free of an electrode, such that the single element is free of any physical attachment to a cathode or anode. Such a single element can be placed adjacent to an electrode in the stack during use. In other aspects, the single element includes one or more electrodes. For example, in some aspects, the single element includes a cathode or an anode physically connected to the current collector (i.e., on a face of the current collector that faces away from the pan). The separator can be placed between the single elements in the stacks, and if the single element does not include an electrode, electrodes can be placed between the single elements and the separators in the stack. The stack can include any suitable number of the single elements.

For example, the stack can include 2 to 200 of the single elements, or 50 to 200 of the single elements, or less than or equal to 200 of the single elements and greater than or equal to 2 of the single elements and less than, equal to, or greater than 3 of the single elements, 4, 5, 6, 7, 8, 9, 10, 11, 12, 14, 16, 18, 20, 22, 24, 26, 28, 30, 35, 40, 45, 50, 60, 70, 80, 90, 100, 120, 140, 160, or 180 of the single elements. The stack can be a ministack; for example, the stack can include 2 to 20 of the single elements, or 3 to 10 of the single elements, or less than or equal to 20 and greater than or equal to 2 and less than, equal to, or greater than 3 of the single elements, 4, 5, 6, 7, 8, 9, 10, 11, 12, 13, 14, 15, 16, 17, 18, or 19 of the single elements.

### Method of Performing Water Electrolysis.

Various aspects of the present invention provide a method of performing water electrolysis. The method includes electrolyzing water using the apparatus for water electrolysis including two or more ministacks described herein, or using the apparatus for water electrolysis including two or more single elements. The method can be a method of performing advanced alkaline water electrolysis. The method can be a method of performing alkaline water electrolysis that includes electrolyzing water via alkaline water electrolysis using the apparatus for water electrolysis described herein. The method can be a method of performing anion exchange membrane water electrolysis that includes electrolyzing water via anion exchange membrane water electrolysis using the apparatus for water electrolysis described herein.

The method can include compressing the two or more ministacks using an electrolyzer frame, such as using backing frames on the frame to provide the compression. The electrolyzer frame can provide compression to the apparatus sufficient to operate the cells at a pressure of 2 psig to 450 psig, or 2 psig to 100 psig, or 30 psig to 100 psig, or 50 psig to 100 psig, or less than or equal to 450 psig and greater than or equal to 2 psig and less than, equal to, or greater than 3 psig, 4, 5, 6, 7, 8, 9, 10, 12, 14, 16, 18, 20, 25, 30, 35, 40, 45, 50, 55, 60, 70, 80, 90, 100, 120, 140, 160, 180, 200, 250, 300, 350, 400, or 440 psig.

### Method of Compressing a Ministack.

In various aspects, the present invention provides a method of manipulation and/or leak testing of the apparatus for water electrolysis including two or more ministacks described herein, or using the apparatus for water electrolysis including two or more single elements. The method can include using tie rods (e.g., thin tie rods) and backing plates (e.g., thin but stiff backing plates) that provide sufficient compression of the apparatus for manipulation of the ministack and or for leak testing of the cells, such as sufficient compression to operate the cells at a pressure of 2 psig to 450 psig, or 2 psig to 100 psig. The tie rods and backing plates alone can provide the sufficient compression.

In various aspects, the present invention provides a method of performing water electrolysis using the apparatus for water electrolysis including two or more ministacks described herein, or using the apparatus for water electrolysis including two or more single elements. The method can include compressing the apparatus using an electrolyzer frame, such as using backing frames on the frame to provide the compression. The electrolyzer frame can provide compression to the apparatus sufficient to operate the cells at a pressure of 2 psig to 450 psig, or 2 psig to 100 psig, or 30 psig to 100 psig, or 50 psig to 100 psig, or less than or equal to 450 psig and greater than or equal to 2 psig and less than, equal to, or greater than 3 psig, 4, 5, 6, 7, 8, 9, 10, 12, 14, 16, 18, 20, 25, 30, 35, 40, 45, 50, 55, 60, 70, 80, 90, 100, 120, 140, 160, 180, 200, 220, 240, 260, 280, 300, 350, 400, or 440 psig.

The electrolyzer frame can including backing plates with a tension mechanism that pulls the two backing plates together to provide the compression, such as including tension cables with an actuator. The electrolyzer frame can include backing plates with a compression mechanism that pushes one backing plate toward the other backing plate to provide the compression, such as via one or more actuators. The actuators can be manually or automatically controlled. To insure correct and uniform loading of the cells, an actuated contact plate can be used with pressure sensing and closed loop force control. In another aspect, a manually actuated contact plate can be used with pressure sensing or with manual gaging of spring compressions created by actuators.

### EXAMPLES

Various aspects of the present invention can be better understood by reference to the following Examples which are offered by way of illustration. The present invention is not limited to the Examples given herein.

### Example 1. (Comparative)

Advanced alkaline water electrolysis is used to produce hydrogen and oxygen gases. Advanced alkaline water electrolysis cells typically include a cathode separated from an anode by a thin separator. The thin separator can be an ion exchange membrane, an ion solvating membrane, or a composite nanoporous membrane.

There are two broad families of electrolyzers: filter press and single element. Filter press architecture utilizes internal manifolding of the fluid flows. Cathode- and anode-side flows are introduced at one end of a cell stack and removed (with the produced gases) from the opposite end of the stack.

A filter press cell stack includes a repeating stack of bi-polar plates (which carries the seals), porous transport layers (PTLs) and membranes (or membrane electrode assemblies (MEA)). Bi-polar plates are metal assemblies that support an anode structure on one side and a cathode structure on the opposite side. At industrially relevant scale a filter press can include well over 100 membranes and bi-polar plates. Large, stiff backing plates bookend the stack. The requisite seals and electrical connections are created simultaneously using an external actuator (or actuators) to compress together the backing plates and the many thin components including the cell stack.

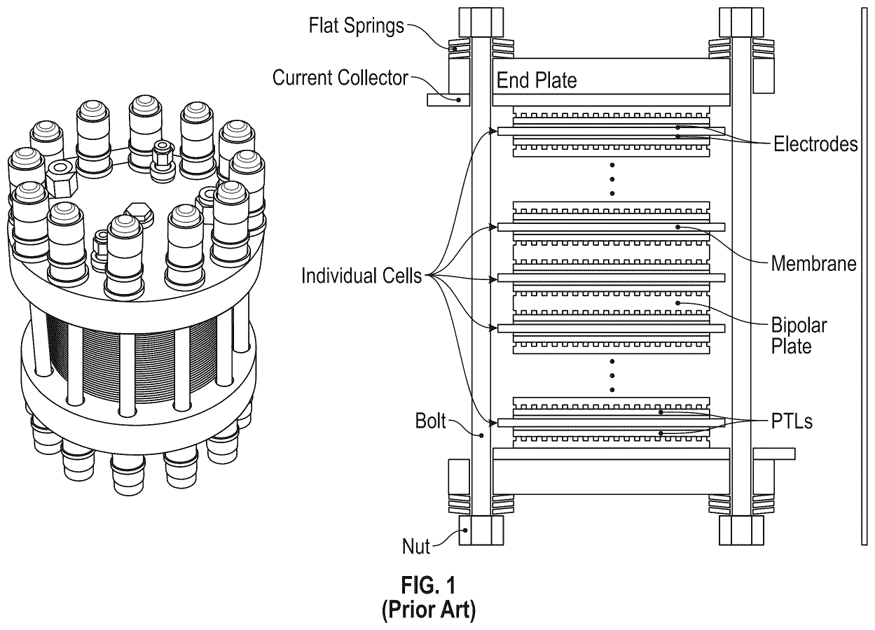

An array of tie rods connecting the backing plates often provides the compressive force necessary to create the requisite seals. FIG. 1 illustrates images that depicts the repeating internal structure of a typical filter press AWE (Reference: K. Bareiß, et al., Applied Energy 237 (2019)), with the left image showing an angled front view and with the right image showing a cross-sectional diagram.

The advantages of filter press electrolyzers include a pathway to relatively low capital costs, compatibility with high-pressure operation, and small footprint. But filter press electrolyzers also suffer from a number of weaknesses. Although, in theory bi-polar plates can be simple, inexpensive structures, advanced bi-polar plates are often complicated, expensive assemblies that utilize advanced processing techniques and combine different materials of construction on the anode and cathode sides, respectively.

Additionally, internally manifolding the flows drives an increase in the complexity of the wetted internal components. Every wetted component, including the membranes, requires through-holes to accommodate the manifolded flows, relatively precise seal locating features and sealing surfaces. The additional fabrication processes required to produce the membranes, seals, PTLs, cell frame, and electrode plates are labor intensive and wasteful of raw materials. Moreover, each machining step and seal not only increases component costs, but also increases the probability of failure.

Hydrogen production scales with current density. So does the power lost to heat generation. Relatively high electrolyte flow rates and outlet flow cross-sectional areas are required to enable reliable operation at high current densities (in excess of ˜0.7 A/cm²). The internal manifolding inherent to the filter press architecture places a practical limit on the maximum flow rates that can used, thereby limiting the cooling capabilities of the system. Moreover, the relatively small flow cross-sections inherent to internal manifolding also make it difficult to efficiently remove large amounts of O₂ and H₂ gas from the system. Those flow rate limitations ultimately limit the maximum current density at which a filter press electrolyzer can operate. Finally, the filter press architecture does not lend itself to maintenance.

Because each cell is compressed within the cell stack, if an issue arises within the stack (e.g., a breached membrane, a failed seal, a degraded electrode coating or a clogged distribution channel), the electrolyzer (cell stack) must be maintained as a system. The whole electrolyzer must be craned out of the cell room, transferred to a maintenance room (or shipped back to the supplier), and then completely disassembled and rebuild. Such a maintenance cycle can easily take weeks to complete.

With a single element architecture each cell is an independently sealed assembly with its own dedicated inlets and outlets. A single element cell typically includes two half-cells: an anode half-cell and a cathode half-cell. A membrane (separator) separates the two half-cells. Half-cells typically include, at a minimum, a pan, an electrode and a metal structure connecting the electrode to the pan. Current flows from the back of the pan through the internal structure to the electrode. The pans are generally flanged. Gaskets or gasket tape are typically used to create a seal between the anode and cathode flanges and the membrane. Loading bars and bolt assemblies are typically used to generate the compression required to make the flange seals. Electrolyte (typically KOH) is introduced into each half-cell via an inlet tube. The outlet flows (KOH and H₂ from the cathode and KOH and O₂ from the anode) exit each half-cell via dedicated outlet tubes.

In practice, an industrially-sized electrolyzer includes a frame containing a large number (50-200) of single element cells. Contact plates electrically connected to the two poles of a rectifier bookend the stack of single elements. One contact plate is “hard-stopped” against insulating blocks attached to the electrolyzer frame. An actuator (or a set of actuators) mounted to the electrolyzer frame drives the opposite contact plate into contact with a first cell, and then each cell into contact with its downstream neighbor to create an electrically continuous path between the two contact plates. The method used to actuate the moveable contact plate varies from aspect to aspect. The actuator can include bolts, hydraulic rams, pneumatic drives, linear motors, and the like.

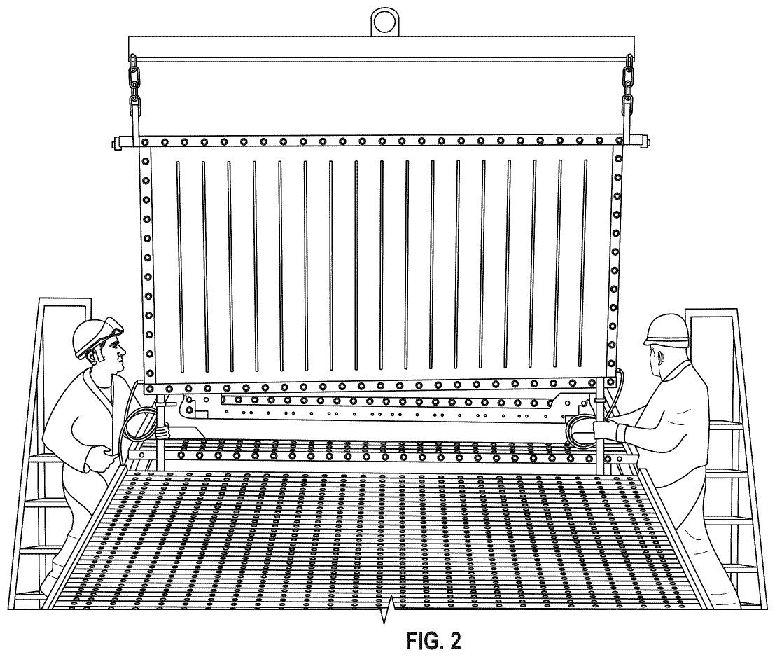

In operation, current flows serially through the cell stack. FIG. 2 illustrates a photograph showing a single element cell being loaded into an electrolyzer. The sealing bolts are visible around the perimeter of the cell. The inlet and outlet tubes can also be seen.

Single element architecture is inherently simpler than conventional filter press architecture and is therefore better suited for the high-volume production required to achieve industrial relevance. Also, since the flow cross-sections can be made arbitrarily large, appropriately designed single element cells can be operated using the high electrolyte flow rates required to enable operation at current densities exceeding 3 A/cm². Finally, because each cell is more or less independent it is possible to develop an optimized maintenance strategy with single element cells. The health of each individual cell can be monitored using parameters such as cell voltage. If a cell is found to need maintenance, the cell stack containing the problematic cell (typically one stack amongst at least 10 similarly sized stacks in an industrially relevant deployment) can be de-powered, and the problematic cell can then be replaced with a spare cell. In the example of a plant including 10 electrolyzers, the nine unaffected electrolyzer stacks can continue operation during the maintenance cycle. The whole operation can be performed in just a few hours. The ability to rapidly replace (and subsequently rework) degraded cells enables a strategic approach to cell maintenance.

Membranes and coatings degrade over time, resulting in an increasing voltage and an associated decrease in efficiency. If maintenance is relatively easy, a plant manager can choose to perform regular preventative maintenance in order to keep all cells operating at a very high efficiency. If maintenance is difficult, expensive and time-consuming, a plant manager might choose to defer maintenance and continue operating a relatively inefficient plant rather than suffering the consequences of a prolonged turnover. Although single element architecture enables a simple and efficient maintenance program, there are, of course, tradeoffs associated with that architecture.

One of the largest tradeoffs is the need to seal each cell. As mentioned above, loading bars and an array of fastening hardware have typically been used to make the seals between half-cells. An industrially relevant cell has an active area in excess of 2 m² and can have an active area as large as 3 m². Relatively thick loading bars and a large quantity of fastener hardware are required to make reliable seals. Adding the bars, bolts, washers and nuts, and then torquing all of the bolts to the appropriate torque requires significant labor. Moreover, the loading bars and associated fastener hardware are also one of the primary determinants of the minimum cell thickness. Cells in a filter press system can be very thin because they do not have to accommodate inlet and outlet nozzles or accommodate loading bars.

Single element cells are intrinsically challenging to operate at high pressures. Half-cell pans are usually formed from a piece of thin sheet metal in order to minimize cell cost. The mini-stack design described herein is more compatible with high pressure operation compared with the traditional single element cell design. The reduced depth of each cell component in the mini-stack and the addition of tie rods and backing plates enables operation at pressures above ambient without the need to significantly increase the thickness of the sheet metal used to form the cell pans.

### Example 2. Array of Mini Filter-Press Stacks

This disclosure describes a hybrid electrolyzer architecture including an array of multiple stacks of cells. The cell stacks could include a relatively small number of cells, such as 2 to 10 cells. A full electrolyzer stack, including 50-200 cells, would include the necessary number of mini-stacks to build up the total desired number of cells. As in a single element aspect, current would flow serially through the array of mini-stacks.

In one aspect, each array resembles a mini-filter press stack. A mini-filter press stack would utilize internal manifolding within each stack. Each mini-stack would include two inlet tubes and two outlet tubes. Backing plates and tie rods could be used to compress the bipolar plates, membranes, spacer plates and seals into a leak tight package. The packing density of an electrolyzer containing a number of mini-stacks would be somewhat less than the packing density of a traditional filter press stack due to the need to accommodate the backing plates. However, that reduction in packing density is more than compensated by improvements to the maintainability of the stack, the ability to pump relatively more electrolyte solution through the stack and an enhanced ability to handle two-phase flows with high gas flowrates.

The use of mini-stacks would greatly facilitate maintenance. Performance metrics such as the mini-stack voltage could be used to monitor the health of each stack. A degraded mini-stack could easily be removed from the electrolyzer and replaced with a pre-built spare.

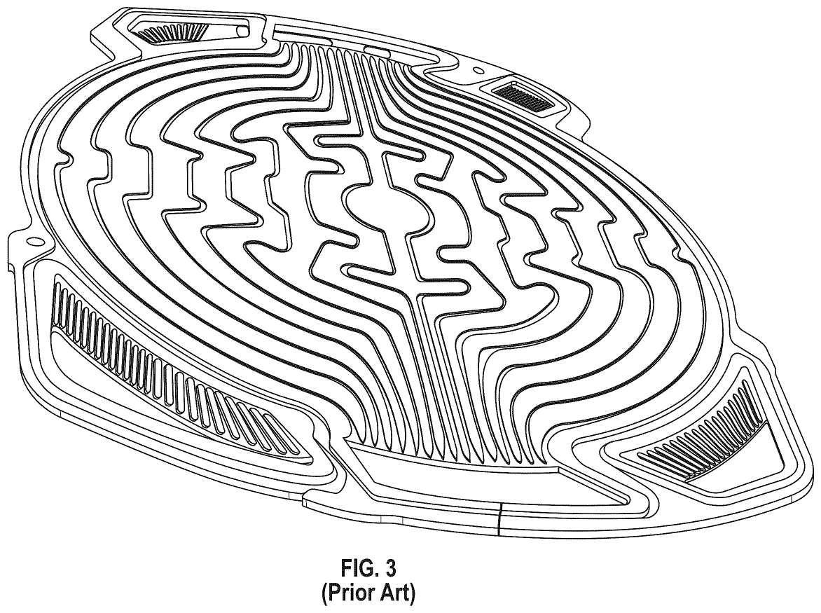

In general, the smaller the number of cells that are included in a stack the easier it is to provide the high internal flow rates (both liquid and gas) necessary to support operation at high current densities. Also, since the number of seals and the number of internal flow distribution features (typically large holes passing through the whole cell stack that feed into shallow channels at the cell level, which in turn feed into a network of narrow, shallow channels that feed or remove fluid from across the cell width) increase linearly with the number of cells within a stack, reducing the number of cells per stack reduces the probability that any particular stack will suffer leaks and/or a clogged distribution channel. A photograph of a typical bipolar plate is shown in FIG. 3; the complexities of the seal and flow designs are evident.

### Example 3. Array of Single Elements

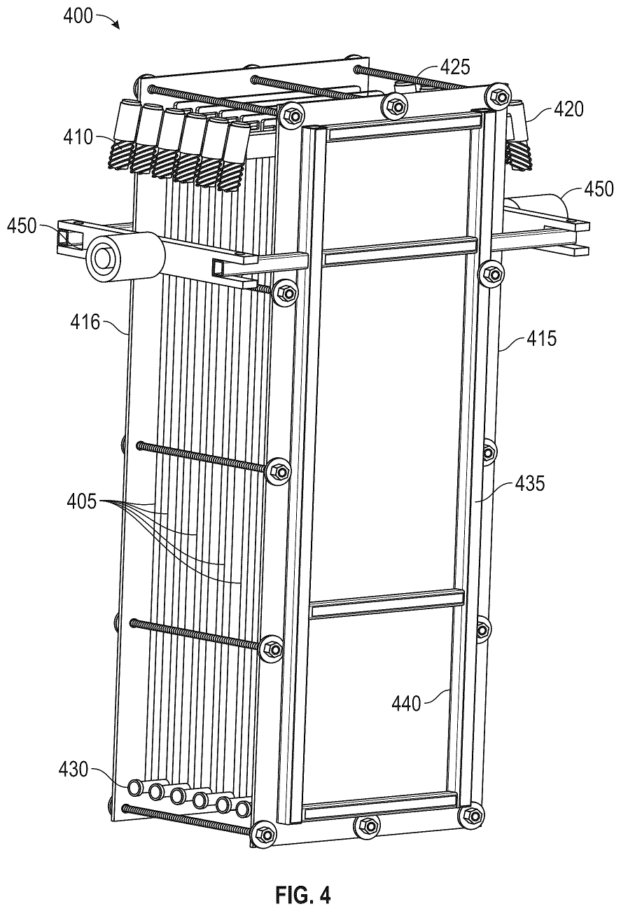

Although a mini-filter press stack offers advantages, an attractive option is a mini-stack including a small number (2-10) of single element-like cells, with cell-specific (not manifolded) flows and a common external structure for creating the seals between the anode and cathode pan pairs including the stack's cells. That is, each cell will have dedicated inlet and outlet tubes attached to both its anode and cathode assemblies. Backing plates will be used to compress the mini-stack such that seals are formed between each anode and cathode and the separator passing between them. Current would flow serially through the first backing plate, through the cell stack and through the second backing plate. FIG. 4 shows one aspect of the invention wherein both the anode and cathodes are constructed as pan-like structures and the mini-stack includes six cells. The stack 400 includes six cells 405 each of which include an anode and a cathode (the nearest of which is hidden behind the backing plate 415). The cells are sandwiched between two backing plates 415 and 416. The backing plates are held together via threaded tie rods 420 bolted to the backing plates. The stack includes six electrolyte outlets 410 for one type of electrode (e.g., anode or cathode) and six electrolyte outlets 420 for the other type of electrode (five of which are hidden behind the stack in the image). The stack includes six electrolyte inlets 430 for one type of electrode and six electrolyte inlets for the other type of electrode which are hidden behind the stack. The stack includes contact strips 435 and backing plate stiffeners 440. The stack includes rollers 450.

In FIG. 4, the six-cell stack is compressed using a number of tie rods connecting two backing plate assemblies. The backing plate assemblies can be weldments including a loading plate and a frame. The loading plate can be nickel or nickel-coated (electroless or electro-plated) carbon steel or nickel-coated stainless steel. The frame members can be nickel tubes or nickel-coated carbon steel tubes or solid members, or nickel-coated stainless-steel tubes or solid members.

Alternatively, as depicted above, the frame members can be carbon steel or stainless-steel tubes with nickel contact strips welded to them. The engineering goals are: 1) provide sufficient compression to make reliable seals; 2) minimize the thickness of the backing plate assemblies; 3) minimize the electrical resistance (both across the contacts and through the materials) through the stack.

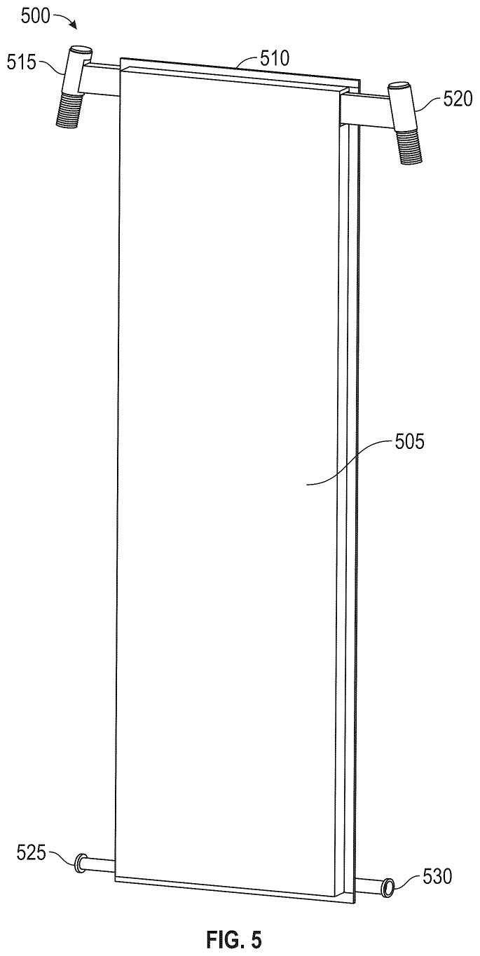

FIG. 5 illustrates an image of one of the cells 500 from the six-cell stack shown in FIG. 4. The cell shown closely resembles a single element cell and can contain the design features described in U.S. Pat. No. 11,390,956B1 that enable efficient operation, hereby incorporated by reference in its entirety. The fundamental difference is that the pan can be shallower and the pan flanges are thinner and do not contain bolt holes. Eliminating the loading bars and sealing hardware (bolts, washers, nuts, etc.) has enabled the pan depths to be reduced significantly. A typical industrially sized single element cell is generally 70-120 mm thick. The thickness of the cell 500 shown in FIG. 5 is only about 50 mm. Cell 500 includes pan 505 with pan flange 510 around the perimeter of the cell. The pan can be a single element weldment. Cell 500 includes electrolyte outlet 515 and electrolyte inlet 530 for one of the electrodes (e.g., anode or cathode), and electrolyte outlet 520 and electrolyte inlet 525 for the other one of the electrodes in the cell.

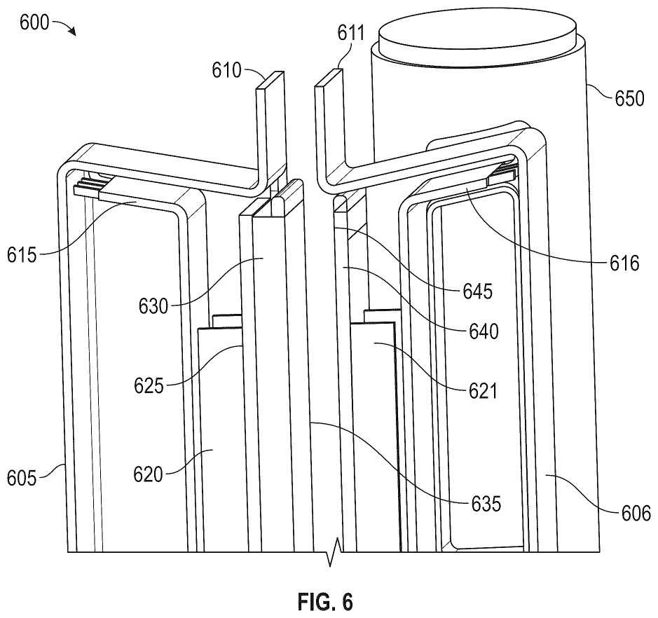

FIG. 6 shows a top cross-section of two half-cells 600. The membrane and the seals are not shown. In practice, the membrane (separator) will sit between the two half-cells and seals will be made all around the flanges. Various seal options are available, including face gaskets, gasket tape, molded edge seals, and the like. Although the pans are typically produced from thin sheet material, a short flange transitioning outward from the pan's vertical (or near-vertical) walls will be sufficiently stiff to create a reliable seal. The two half-cells 600 include pans 605 and 606 which include pan flanges 610 and 611, respectively. Within each pan is an internal header 615 and 616 which contact ribs 620 and 621. The ribs contact current collectors 625 and 640. Adjacent to current collector 625, one half-cell includes elastic element 630 which contacts the electrode 635 (e.g., an anode or cathode). The electrode 635 includes a fold at the top thereof. Adjacent to the current collector 640 in the other half-cell is the other electrode 645, which also includes a fold at the top thereof. The two half-cells include electrolyte outlet tube 650. In practice, the separator can be between electrodes 635 and 645 with seals formed at the flanges 610 and 611.

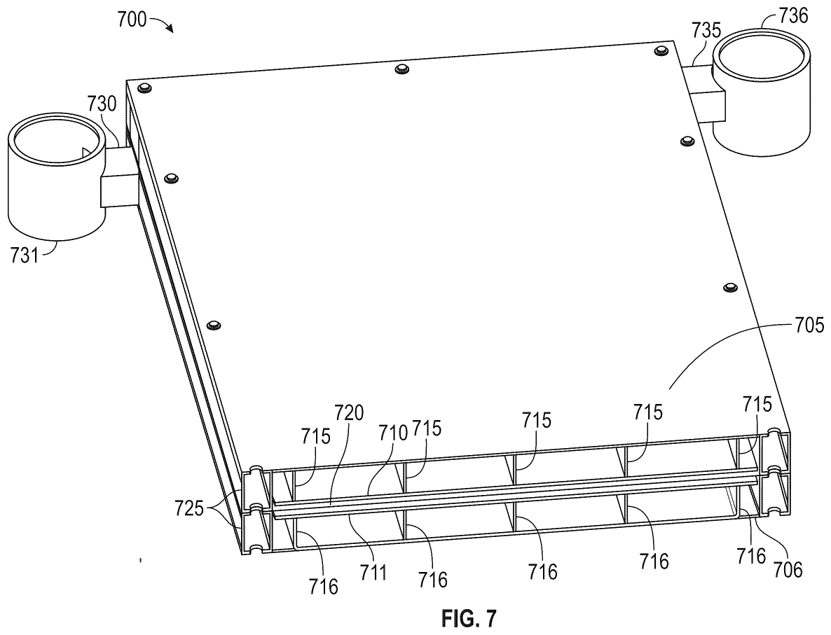

Rather than pans formed by bending and welding a piece of nickel sheet, the half-cell structures could include a flat sheet to which walls are attached, as depicted in the image shown in FIG. 7.

FIG. 7 illustrates a top cross-section of two half-cells 700. One half-cell includes pan 705 is welded to ribs 715 which in turn contact current collector 710. The other half-cell includes pan 706 which is welded to ribs 716 which in turn contact current collector 711. Between the current collectors 710 and 711 is an anode and cathode sandwiching a membrane separator shown as 720. The two half-cells include pan walls 725 which are around the circumference of each half-cell. One half-cell includes outlet 730 connected to outlet manifold 731, and the other half-cell includes outlet 735 connected to manifold 736.

Ribs or rib plates can be welded to one or both surfaces of the pans. If the ribs are attached to both surfaces of the pan, the pan assembly is a bi-polar plate. The pan walls can be made by attaching frame elements around the perimeter of the pan, for example via welding, brazing, glueing, fastening, and the like. In the FIG. 7, the pan walls 725 are depicted as thin-walled rectangular tubes. In practice the pan walls can be fabricated out of tubes or solid elements. The pan walls can be fabricated from nickel, stainless steel, carbon steel, nickel-coated stainless or carbon steel, or polymers such as PTFE, PP, PEEK, and the like. In various aspects, the pan walls can serve as electrolyte channels, as described further herein at Example 5.

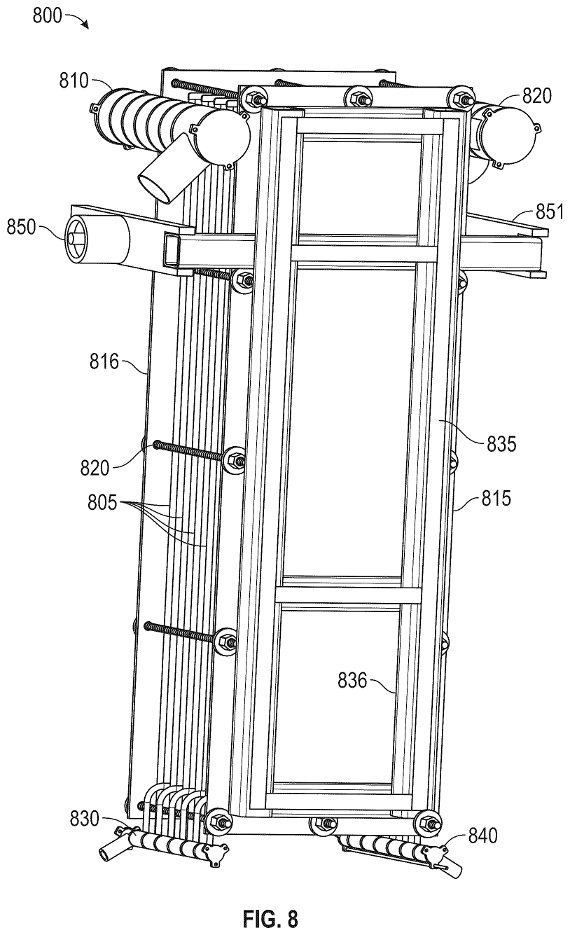

Yet another variation of the mini-stack concept is to externally “gang” the inlets and outlets such that the flows into and out of each stack's anodes and cathodes are locally manifolded outside of the stack. Such an aspect eliminates a significant number of inlet and outlet tubes from the electrolyzer. FIG. 8 illustrates an image depicting ganged inlets and outlets of adjacent cells. FIG. 8 illustrates a stack 800 that is similar to the stack shown in FIG. 4. Stack 800 includes six cells 805 some of which are hidden behind backing plate 815. The cells are sanwhiched between two backing plates 815 and 816. The backing plates are head together via threaded tie rods 820 bolted to the backing plates. The stack includes six electrolyte outlets 810 for one type of electrode (e.g., anode or cathode) and six electrolyte outlets 820 for the other type of electrode (some of which are hidden behind the stack). The stack includes six electrolyte inlets 830 for one type of electrode and six electrolyte inlets 840 for the other type of electrode. The stack includes rollers 850 and 851. The stack includes contact strips 835 and backing plate stiffeners 836.

In stack 800, the inlets and the outlets of each cell within the mini-stack are fastened together by an array of small tie rods (compared to the tie rods that secures the electrode pans of the mini-stack). The ministack includes two inlet tube assemblies per mini-stack connecting the inlet headers and the mini-stack (one for anolyte, one for catholyte), and two outlet tube assemblies per mini-stack connecting the outlet headers and the ministack. Sealing tape, o-rings or gaskets can be sandwiched between inlets and between outlets to hermetically seal them. The sealing tape, o-rings or gaskets can also provide the mechanical compliance required to accommodate the tolerances of the machined and welded inlet and outlet components.

As mentioned above, the mini-stack architecture facilitates the operation of single-element-like cells at pressures above ambient. The tie rods and backing plates will react out internal forces that would otherwise tend to deform the pan floors outward. The net effect of the addition of the backing plates is to reduce the loads that need to be supported by the large electrolyzer frame. It is possible to design backing plates that can react out essentially all the internal stresses that result from operation at moderate pressures (up to 450 psig, or up to 100 psig). However, an alternative architecture described further herein at Example 6 has the backing plates support the mini-stacks during low-pressure testing and cell loading and manipulation, and the electrolyzer frame/contact plate assembly providing the brunt of the load required to produce the seals and react out the internal stresses created by operating the cells/stacks at elevated pressures.

Reducing the pan depth stiffens the pan structure in directions parallel to the pan floor. Even if the electrolyzer frame was infinitely stiff, the maximum pressure that a single element cell could withstand would generally be fairly low due to the relatively low stiffness of the sidewalls of the single-element pans. The stiffness of the sidewalls increases as the sidewall height is reduced. If the pan depth can be reduced sufficiently and the pan floor is appropriately supported, a rectangular single element can support operation at pressures well above ambient.

In addition to decreasing the pan depth, integrating thicker pan side walls into the half-cell assemblies would also enable operation at higher internal pressures (e.g., 1-10 barg for single element cells). Traditionally, single element pans have been formed from a thin sheet metal via bending operations. In that case, the thickness of the side walls equals the thickness of the pan floor, which equals the thickness of the base sheet metal. An alternative approach, enabling the fabrication of a high pressure single element cell would be to use a thicker material for the side walls of the half-cell pans. Such a structure would require additional manufacturing process steps to attach the walls to the base sheet. However, the extra manufacturing complexity might well be warranted, depending upon the complexity of those manufacturing steps and the cost savings realized by simplifying the downstream H₂ compression.

### Example 4. Bi-Polar Pan Single Element

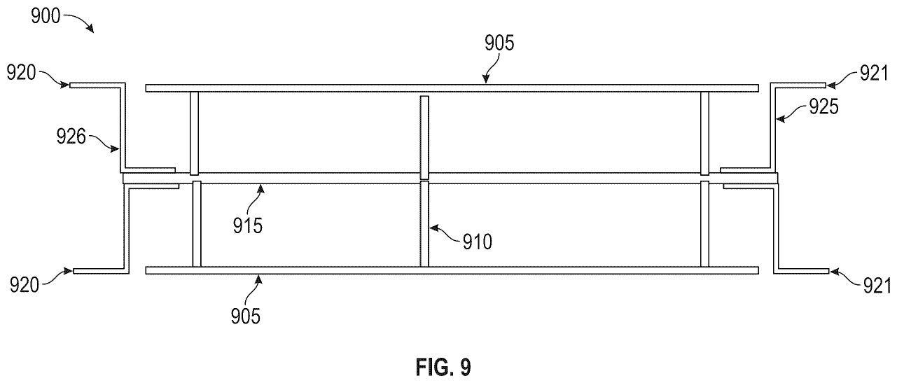

A variation to the above design is a “bi-polar pan” structure. A bi-polar pan structure can be fabricated by attaching side walls to both sides of a flat sheet. The walls could be fabricated as bent sheet or as roll formed elements or as custom extruded members. The attachments could be made via welding or brazing, perhaps even via gluing. Ribs, current collectors, manifolds, baffle sheets, current collectors, inlets and outlets could all be welded to both sides of the base sheet, producing, in effect, back-to-back pan assemblies sharing a pan floor. Utilizing bi-polar pans would minimize material requirements (and associated capital expenditures) and also eliminate the contact resistance between adjacent cells. The image shown in FIG. 9 presents a cross-section of an example bi-polar pan 900 which includes current collectors 905. The current collectors contact ribs 910 which are in turn welded to the pan 915. The pan 915 includes flanges 920 and 921. The pan includes pan walls 925 and 926.

Additional fabrication options, including stamping and drawing, become possibilities as the depth of the pan is reduced. Stamping and drawing represent pathways to very low cost cells.

### Example 5. Tube-Frame Cell Architecture with Internal or External Manifolding

Tubes can be used for perimeter walls or supports (e.g., pan walls) with the tubes being used as inlet and/or outlet headers. For example, rectangular tubes can be used for perimeter walls with lower and upper tubes serving as inlet and outlet headers, respectively. The tubes can be attached around the perimeter of the pan, for example via welding, brazing, glueing, fastening, and the like. The tubes can be fabricated from nickel, stainless steel, carbon steel, nickel-coated stainless or carbon steel, or polymers such as PTFE, PP, PEEK, and the like.

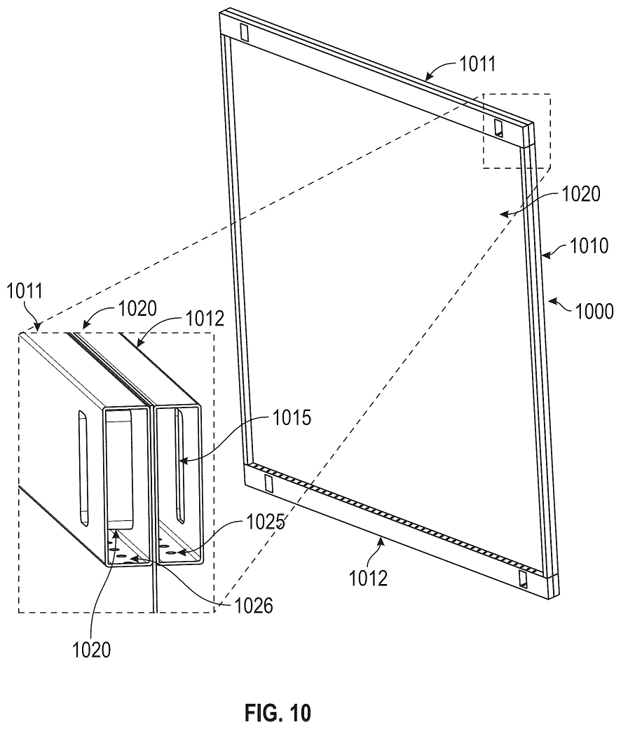

FIG. 10 illustrates walled pan 1000 that includes flat pan 1020 and a frame including side portions 1010, top portion 1011, and bottom portion 1020. Walled pan 1000 can be used between two cells, with one side of the pan 1020 providing a cathode electrolyte compartment and with the other side of the pan 1020 providing an anode electrolyte compartment. The side portion 1010 of the frame can be solid or hollow, while the top 1011 and bottom 1012 of the frame include rectangular hollow tubes. The top of the pan includes hollow rectangular tubes 1011 and 1012 which sandwich the pan. The hollow rectangular tube 1011 includes orifices 1026 to allow electrolyte to enter the tube 1011. The hollow rectangular tube 1012 includes orifices 1025 to allow electrolyte from the other side of the pan to enter the tube 1012. The hollow rectangular tube 1011 includes pass-through 1020 which allows electrolyte to pass through the frame to or from another hollow rectangular tube. Pass-through 1020 unites electrolyte compartments servicing the same type of electrode (e.g., cathode or anode). The hollow rectangular tube 1012 includes opening 1015 which allows electrolyte to pass through the frame to or from another hollow rectangular tube. Opening 1015 unites electrolyte compartments that service the opposite type of electrode as services by the electrolyte flowing through pass-through 1020. When multiple walled pans 100 are stacked with cells therebetween, pass-through 1020 and opening 1015 unite electrolyte compartments servicing anodes and cathodes while avoiding allowing anode electrolyte and cathode electrolyte to mix. The lower tubes of the frame can include similar orifices, pass-throughs, and openings, allowing anode electrolyte and cathode electrolyte to be flowed into the respective electrolyte compartments without mixing the anode electrolyte and cathode electrolyte.

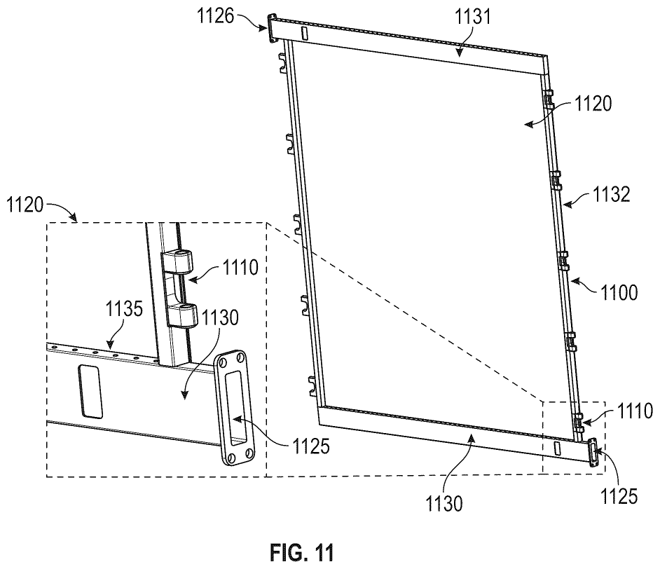

FIG. 11 illustrates walled pan 1100 that includes flat pan 1120 and a frame including side portions 1132, top portion 1131, and bottom portion 1130. Walled pan 1100 can be used adjacent to a single cell on the end of a stack or ministack to provide an electrolyte compartment for the anode or cathode of the cell. The side portion 1132 of the frame includes a feature 1110 that enables attachment of a tie rod. The side portion 1132 of the frame can be solid or hollow, while the top 1131 and bottom 1130 portions of the frame include a rectangular hollow tube. The upper rectangular hollow tube includes electrolyte outlet 1126. The lower rectangular hollow tube includes electrolyte inlet 1125. The lower rectangular hollow tube also includes orifices 1135, which allow electrolyte flowed into the lower rectangular hollow tube via inlet 1125 to enter the electrolyte compartment. Walled pan 1100 includes an electrolyte outlet on the upper portion of the frame. The upper rectangular tube can include similar orifices to allow electrolyte to pass out of the electrolyte compartment and into the upper rectangular tube to exit the stack or ministack via outlet 1126.

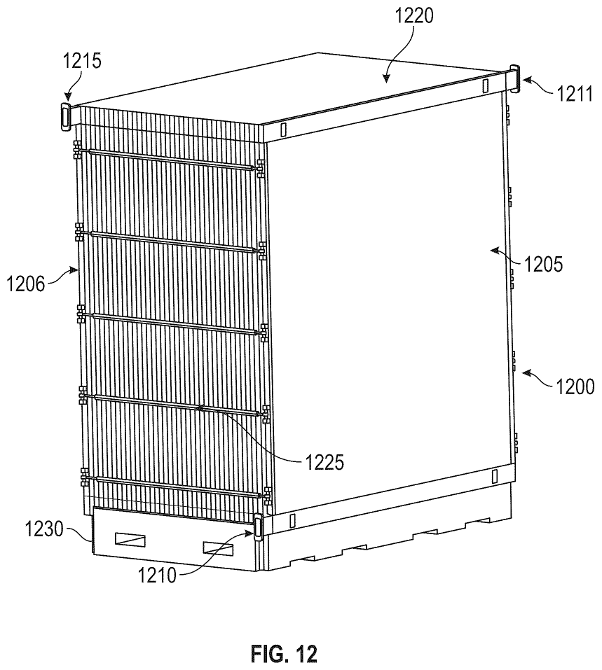

FIG. 12 illustrates a stack or ministack 1200. The stack or ministack 1200 includes outer walled pans 1205 and 1206 which are the same as the walled pan shown in FIG. 11. The outer walled pan 1205 includes inlet 1210 and outlet 1211. The outer walled pan includes outlet 1215 and an inlet hidden behind the image. The stack or ministack 1200 includes a stack of walled pans 1220 having cells therebetween. The walled pans included in the stack of walled pans 1220 are the same as the walled pan shown in FIG. 10. The stack or ministack 1200 includes tie rods 1225. The stack or ministack 1200 includes internal electrolyte channels in the top and bottom frame tubes and internal manifolding via the openings and pass-throughs in the top and bottom frame tubes of the walled pans included in the stack of walled pans 1220. The stack or ministack includes pallet 1230, which can be used for handling (e.g., moving around at ground level), alignment, electrical isolation, and may or may not include rolling or low-friction features for improved compression of the stack within the frame of the electrolyzer. The pallet can eliminate the need for hanging or lifting with an overhead crane.

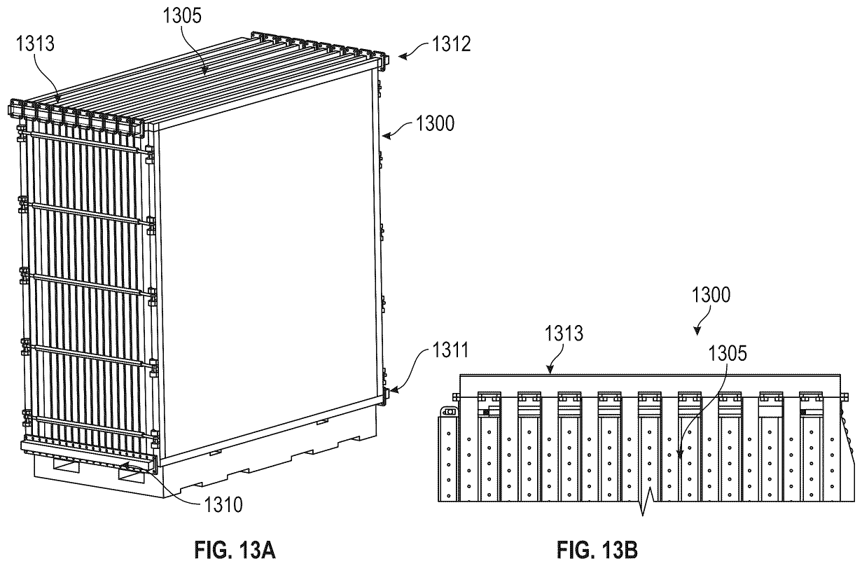

FIG. 13A illustrates a stack or ministack 1300, and FIG. 13B illustrates a top view of the stack or ministack 1300. Like the stack or ministack shown in FIG. 12, stack or ministack 1300 also includes outer walled pans that sandwich a stack 1305 of walled pans having cells therebetween. However, the stack 1305 lacks the pass-throughs and openings of the walled pan shown in FIG. 10. Instead, the stack 1305 disperses inlet electrolyte to electrolyte compartments for one type of electrode (e.g., anode or cathode) via external manifold 1310, and disperses inlet electrolyte to electrolyte compartments for the other type of electrode via external manifold 1311. Likewise, the stack 1305 combines outlet electrolyte from electrolyte compartments for one type of electrode via external manifold 1312, and combines outlet electrolyte from electrolyte compartments for the other type of electrolyte via external manifold 1313.

### Example 6. Reduction of Compression Hardware

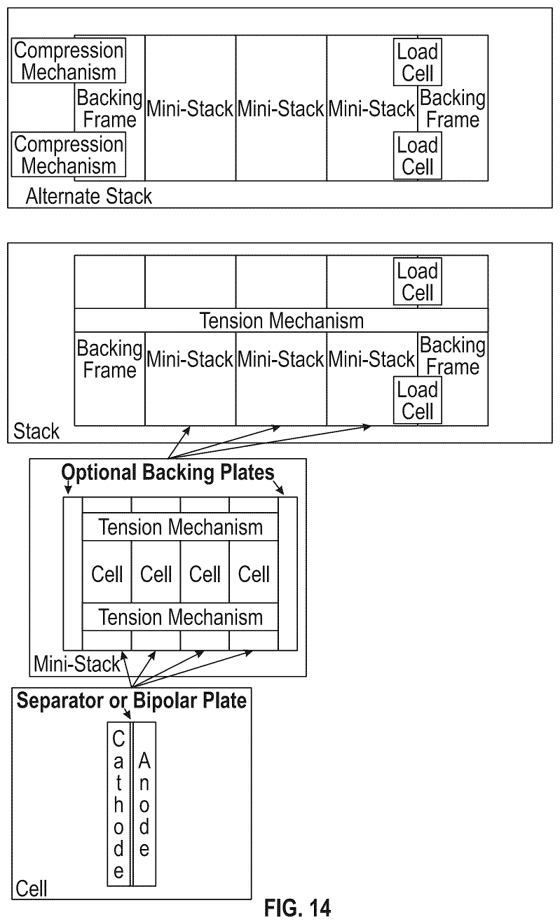

FIG. 14 illustrates in the lower image a cell including an anode and a cathode that sandwich a separator or bipolar plate. The second image from the bottom illustrates a ministack that includes four of the cells and also includes cathode electrolyte compartments and anode electrolyte compartments (not shown). The ministack is held together for manipulation, cell loading, and leak testing (e.g., 0.25 psig to 2 psig) using backing plates that are held together via a tension mechanism which can be thin tie rods/loading bars. The seal(s) created with the loading bars and backing plates only have to produce a seal at low pressures to enable leak testing the membrane (e.g., screen against pin holes) and ensure the seal and flange will produce a reliable seal, and to enable manipulation of the assembled cell or mini-stack (e.g., transfer from the build table to the leak tester and on to the electrolyzer frame).

The second image from the top of FIG. 14 illustrates a stack including three of the mini-stacks. The stack is held together for use (e.g., 2 psig to 450 psig, or 2 psig to 100 psig) using backing frames which are components of an electrolyzer frame. The compression can be provided via the tension mechanism which pulls the backing frames toward one another. The top image illustrates an alternative stack including three of the mini-stacks. The stack is held together for use using backing frames, but the compression is provided by a compression mechanism that pushes one of the backing frames toward the other backing frame.

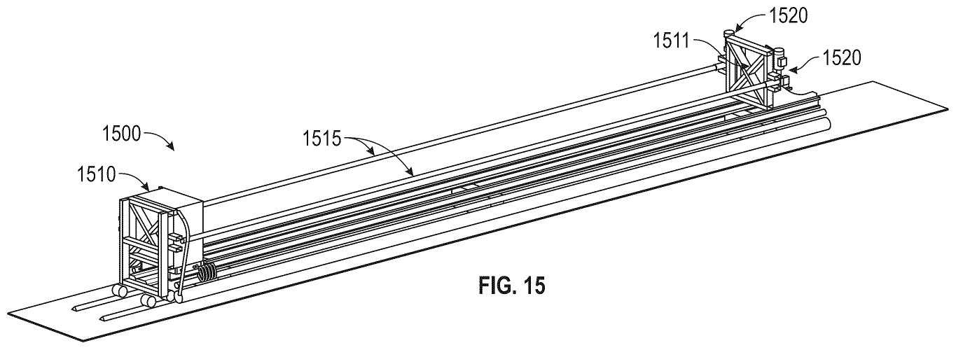

FIG. 15 illustrates a compression mechanism 1500 for compressing one or more ministacks and that can provide the compression shown in the second image from the top of FIG. 14. The compression mechanism 1500 pulls one backing frame 1510 toward the other backing frame 15110 using tension wires 1515 that are brought under tension via use of actuators 1520.

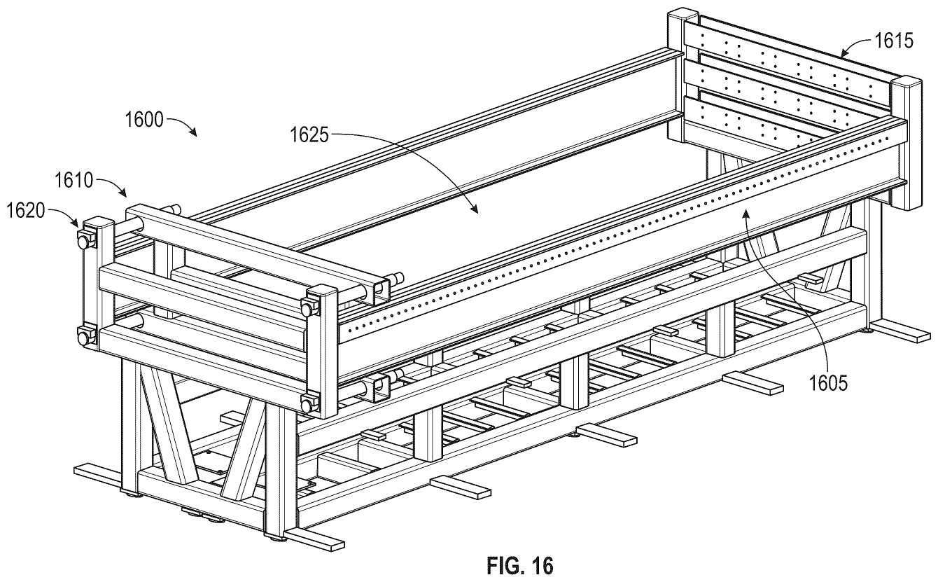

FIG. 16 illustrates an electrolyzer frame 1600 that includes a compression mechanism for compressing one or more ministacks that can be placed in the center of the frame 1625 and that can provide the compression shown in the top image of FIG. 14. Electrolyzer frame 1600 includes backing frames 1615 and 1610. The electrolyzer frame 1600 includes actuators 1620 that push backing frame 1610 toward backing frame 1615 to provide the compression.

The electrolyzer frame can be used to apply sufficient force to ensure a good seal and support the cell or mini-stack when the cell(s) are pressurized to moderate operating pressures (2-450 psig, or 2-100 psig). The backing plates of the ministacks must be sufficiently stiff that they do not deform more than about 1 mm when the cell/stacks are pressurized. The loading plates/backing frames, which can be mechanically attached to the electrolyzer frame, can be automatically or manually driven. The pre-load can be generated in an open loop or a closed loop fashion. If open loop, a gage can be used to measure, for instance, the compression of a stack of Belleville washers that are in-line with the force creating actuator. If closed loop, load cells can be used to measure the contact force at one or several positions to insure correct and uniform loading.

The protocols of this Example eliminate the need to use thick stiff loading bars and relatively bulky hardware to seal each cell or mini-stack.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects

The following exemplary aspects are provided, the numbering of which is not to be construed as designating levels of importance:

Aspect 1 provides an apparatus for water electrolysis, the apparatus comprising:

two or more ministacks electrically connected in series and/or in parallel, each ministack comprising a stacked arrangement of 2 to 20 cells that are electrically connected in series, each cell comprising
an anode,
a cathode,
a separator between the anode and the cathode, and
a fluid flow system permitting anode electrolyte to be added to the cell, flowed in contact with the anode, and removed from the cell, and permitting cathode electrolyte to be added to the cell, flowed in contact with the cathode, and removed from the cell.

Aspect 2 provides the apparatus of Aspect 1, wherein each ministack comprises 3 to 10 of the cells.

Aspect 3 provides the apparatus of any one of Aspects 1-2, wherein the two or more ministacks are electrically connected in series.

Aspect 4 provides the apparatus of any one of Aspects 1-3, wherein the two or more ministacks are electrically connected in parallel.

Aspect 5 provides the apparatus of any one of Aspects 1-4, wherein the fluid flow systems of the cells of the ministack are connected in parallel such that the anode electrolyte and the cathode electrolyte flows through the cells of the ministack in parallel.

Aspect 6 provides the apparatus of any one of Aspects 1-5, wherein the apparatus comprises 2 to 200 of the ministacks.

Aspect 7 provides the apparatus of any one of Aspects 1-6, wherein the apparatus is configured to flow anode and/or cathode electrolyte solution through the one or more ministacks in parallel.

Aspect 8 provides the apparatus of any one of Aspects 1-7, wherein the anode electrolyte and the cathode electrolyte independently comprise an aqueous solution comprising a base.

Aspect 9 provides the apparatus of any one of Aspects 1-8, wherein the anode electrolyte and the cathode electrolyte independently comprise an aqueous solution comprising NaOH, KOH, or a combination thereof.

Aspect 10 provides the apparatus of any one of Aspects 1-9, wherein the anode electrolyte and the cathode electrolyte independently have a concentration of NaOH and/or KOH of 0 M to 10 M.

Aspect 11 provides the apparatus of any one of Aspects 1-10, wherein the anode electrolyte and the cathode electrolyte independently have a concentration of NaOH and/or KOH of 0.1 M to 9 M.

Aspect 12 provides the apparatus of any one of Aspects 1-11, wherein the anode and the cathode independently comprise Ni, stainless steel, carbon, carbon steel, titanium, platinum, or a combination thereof.

Aspect 13 provides the apparatus of any one of Aspects 1-12, wherein the anode and/or the cathode independently comprise an electrocatalyst comprising a platinum group metal (e.g., Ru, Pt, Ir), nickel, iron, cobalt, manganese, copper, or a combination thereof.

Aspect 14 provides the apparatus of any one of Aspects 1-13, wherein the ministack further comprises two backing plates that sandwich the two or more cells in the ministack.

Aspect 15 provides the apparatus of Aspect 14, wherein the backing plates comprise nickel, copper, stainless steel, carbon steel, titanium, or stainless steel or titanium coated with nickel.

Aspect 16 provides the apparatus of any one of Aspects 14-15, further comprising one or more tie rods physically connecting the backing plates to each other.

Aspect 17 provides the apparatus of any one of Aspects 14-16, wherein the one or more tie rods compress the backing plates sufficiently to operate the cells at a pressure of 0.25 psig to 2 psig.

Aspect 18 provides the apparatus of any one of Aspects 1-17, further comprising one or more seals between the anode and the separator, the separator and the cathode, or a combination thereof.

Aspect 19 provides the apparatus of any one of Aspects 1-18, wherein the cell further comprises a cathode current collector, wherein the cathode current collector and the separator are adjacent to the cathode and sandwich the cathode.

Aspect 20 provides the apparatus of Aspect 19, wherein the cathode current collector and the cathode are separate components.

Aspect 21 provides the apparatus of Aspect 19, wherein the cathode is a coating on the current collector.

Aspect 22 provides the apparatus of any one of Aspects 1-21, wherein the cell further comprises an elastic element between the cathode current collector and the cathode.

Aspect 23 provides the apparatus of any one of Aspects 1-22, wherein the cell further comprises an anode current collector, wherein the anode current collector and the separator are adjacent to the anode and sandwich the anode.

Aspect 24 provides the apparatus of Aspect 23, wherein the anode current collector and the anode are separate components.

Aspect 25 provides the apparatus of Aspect 23, wherein the anode is a coating on the current collector.

Aspect 26 provides the apparatus of any one of Aspects 1-25, wherein the cell further comprises an elastic element between the anode current collector and the anode.

Aspect 27 provides the apparatus of any one of Aspects 1-26, wherein the anode, the cathode, and the separator are planar.

Aspect 28 provides the apparatus of any one of Aspects 1-27, wherein the anode, the cathode, and the separator have a perimetric profile of a square, a rectangle, a circle, an oval, or a polygon.

Aspect 29 provides the apparatus of any one of Aspects 1-28, wherein the ministack has an external profile of a disc, a cylinder, an oval cylinder, a cuboid, or a rectangular cuboid.

Aspect 30 provides the apparatus of any one of Aspects 1-29, wherein the apparatus is for alkaline water electrolysis or anion exchange membrane water hydrolysis.

Aspect 31 provides the apparatus of any one of Aspects 1-30, wherein the apparatus is for alkaline water electrolysis.

Aspect 32 provides the apparatus of Aspect 31, wherein the anode electrolyte and the cathode electrolyte are aqueous solutions that independently have a concentration of NaOH and/or KOH of 3 M to 10 M.

Aspect 33 provides the apparatus of any one of Aspects 31-32, wherein the anode electrolyte and the cathode electrolyte are aqueous solutions that independently have a concentration of NaOH and/or KOH of 4 M to 8 M.

Aspect 34 provides the apparatus of any one of Aspects 31-33, wherein the separator comprises a membrane that is conductive to ions and substantially non-conductive to electricity, oxygen gas, and hydrogen gas.

Aspect 35 provides the apparatus of Aspect 34, wherein the membrane is non-selectively permeable to ions and is permeable to ⁻OH ions.

Aspect 36 provides the apparatus of any one of Aspects 31-35, wherein the separator comprises PSU/ZrO₂, alkaline-stable hexyltrimethyl ammonium-functionalized Diels-Alder poly(phenylene) (HTMA-DAPP), quaternized polycabozole-trimethyl amine (QPC-TMA), poly(2,2′-(m-phenylene)-5,5-bibenzimidazole) (m-PBI), poly(fluorenyl-co-terphenyl piperidinium) (PFTP), poly(fluorenyl-co-aryl piperidinium) (PFAP), or a combination thereof.

Aspect 37 provides the apparatus of any one of Aspects 1-36, wherein the apparatus is for anion exchange membrane water hydrolysis, wherein the separator comprises an anion exchange membrane.

Aspect 38 provides the apparatus of Aspect 37, wherein the anion exchange membrane is conductive to OH ions and is substantially non-conductive to electricity, oxygen, and hydrogen.

Aspect 39 provides the apparatus of any one of Aspects 37-38, wherein the anion exchange membrane comprises a polymer comprising a poly(arylene ether)-based backbone, polyolefin-based backbone, polyphenylene-based backbone, a backbone containing a cationic moiety, or a combination thereof.

Aspect 40 provides the apparatus of any one of Aspects 37-39, wherein the separator comprises a membrane that is based on alkaline-stable hexyltrimethyl ammonium-functionalized Diels-Alder poly(phenylene) (HTMA-DAPP), quaternized polycabozole-trimethyl amine (QPC-TMA), poly(2,2′-(m-phenylene)-5,5-bibenzimidazole) (m-PBI), poly(fluorenyl-co-terphenyl piperidinium) (PFTP), poly(fluorenyl-co-aryl piperidinium) (PFAP), or a combination thereof.

Aspect 41 provides the apparatus of any one of Aspects 1-40, wherein the ministack includes a filter press.

Aspect 42 provides the apparatus of Aspect 41, wherein the ministack comprises one or more anode electrolyte channels between and within the cells of the ministack, and one or more cathode electrolyte channels between and within the cells of the ministack.

Aspect 43 provides the apparatus of any one of Aspects 41-42, wherein the fluid flow system flows anode electrolyte through one or more anode electrolyte channels between an anode inlet manifold and the cells of the ministack and/or flows cathode electrolyte through one or more cathode electrolyte channels between a cathode inlet manifold and the cells of the ministack.

Aspect 44 provides the apparatus of any one of Aspects 41-43, wherein the fluid flow system flows anode electrolyte through one or more anode electrolyte channels between an anode outlet manifold and the cells of the ministack and/or flows cathode electrolyte through one or more cathode electrolyte channels between a cathode outlet manifold and the cells of the ministack.

Aspect 45 provides the apparatus of any one of Aspects 42-44, wherein the one or more anode electrolyte channels and/or the one or more cathode electrolyte channels comprise hollow tubes of a frames adjacent to electrolyte compartments for each anode and cathode.

Aspect 46 provides the apparatus of Aspect 45, wherein the hollow tubes of an upper portion of the frames comprise outlet headers.

Aspect 47 provides the apparatus of any one of Aspects 45-46, wherein the hollow tubes of a lower portion of the frames comprise inlet headers.

Aspect 48 provides the apparatus of any one of Aspect 45-47, wherein the ministack comprises internal manifolding of cathode and/or anode electrolyte streams.

Aspect 49 provides the apparatus of any one of Aspects 45-47, wherein the ministack comprises external manifolding of cathode and/or anode electrolyte streams.

Aspect 50 provides the apparatus of any one of Aspects 1-49, wherein the ministack is a stack of single elements, each single element comprising
a pan;
a current collector parallel to the pan;
a gap between the pan and the current collector;
one or more electrically conductive connectors between the pan and the current collector that physically connect the pan and the current collector;
an inlet that allows electrolyte to flow into the gap and into contact with an electrode adjacent to a face of the current collector that faces away from the pan; and
an outlet to allow electrolyte to flow out of the gap;
wherein the inlet and the outlet are independently located at one or more edges of the single element, and wherein the pan and the current collector together form a cavity therebetween.

Aspect 51 provides the apparatus of Aspect 50, wherein the ministack comprises the separators of the cells of the ministack between the single elements.

Aspect 52 provides the apparatus of Aspect 51, wherein the ministack comprises the anode, the separator, and the cathode of the cells of the ministack between the single elements.

Aspect 53 provides the apparatus of any one of Aspects 50-52, wherein the single element is free of the electrode.

Aspect 54 provides the apparatus of any one of Aspects 50-53, wherein the single element and the electrode are free of physical connection therebetween.

Aspect 55 provides the apparatus of any one of Aspects 50-54, wherein the single element comprises the electrode physically connected to the current collector, wherein the electrode is the cathode of a cell.

Aspect 56 provides the apparatus of any one of Aspects 50-55, wherein the single element comprises the electrode physically connected to the current collector, wherein the electrode is the anode of a cell.

Aspect 57 provides the apparatus of any one of Aspects 50-56, wherein the single element is free of additional current collectors that are physically connected to the pan.

Aspect 58 provides the apparatus of any one of Aspects 50-57, wherein the single element is free of additional current collectors.

Aspect 59 provides the apparatus of any one of Aspects 50-58,
wherein the pan is electrically conductive, the current collector is a first current collector, the one or more electrically conductive connectors comprises one or more first electrically conductive connectors, the inlet and outlet are a first inlet and a first outlet, the cavity is a first cavity, the gap is a first gap, and wherein on an opposite face of the pan the single element further comprises
a second current collector parallel to the pan;
a second gap between the second current collector and the pan;
one or more second electrically conductive connectors between the pan and the second current collector that physically connect the pan and the second current collector;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween,
or,
wherein the pan is electrically non-conductive, the current collector is a first current collector, the inlet and outlet are a first inlet and first outlet, the cavity is a first cavity, the gap is a first gap, the one or more electrically conductive connectors pass through the pan and physically connector the first current collector and a second current collector, and wherein on an opposite face of the pan the single element further comprises
the second current collector parallel to the pan;
a second gap between the second current collector and the pan;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

Aspect 60 provides the apparatus of Aspect 59, further comprising the anode of a cell adjacent to the first current collector and the cathode of a cell adjacent to the second current collector, or further comprising the cathode of a cell adjacent to the first current collector and the anode of a cell adjacent to the second current collector.

Aspect 61 provides the apparatus of any one of Aspects 50-60, wherein the one or more conductive connectors are welded to the pan.

Aspect 62 provides the apparatus of any one of Aspects 50-61, wherein the one or more conductive connectors are welded to the first or second current collectors.

Aspect 63 provides the apparatus of any one of Aspects 50-61, wherein the one or more conductive connectors are attached to the first or second current collectors using clips.

Aspect 64 provides the apparatus of Aspect 63, wherein the clips are welded to the current collector.

Aspect 65 provides the apparatus of any one of Aspects 50-64, wherein the conductive connector comprises a rib, a rib plate, or a combination thereof.

Aspect 66 provides the apparatus of any one of Aspects 50-65, wherein the conductive connector comprises a rib.

Aspect 67 provides the apparatus of any one of Aspects 50-66, wherein the pan comprises a flange that forms a seal with a flange of a pan of an adjacent single element.

Aspect 68 provides the apparatus of Aspect 67, wherein the flange is free of fastener holes.

Aspect 69 provides the apparatus of any one of Aspects 50-68, wherein the inlets of adjacent single elements in the ministack sealingly align and fluidly connect with one another.

Aspect 70 provides the apparatus of any one of Aspects 50-69, wherein the outlets of adjacent single elements in the ministack sealingly align and fluidly connect with one another.

Aspect 71 provides the apparatus of any one of Aspects 50-70, wherein the pan is a single continuous sheet with bent sides forming edges.

Aspect 72 provides the apparatus of Aspect 71, wherein the bent sides have a thickness identical to a thickness of a bottom of the pan.

Aspect 73 provides the apparatus of Aspect 71, wherein the bent sides have a thickness that exceeds a thickness of a bottom of the pan.

Aspect 74 provides the apparatus of any one of Aspects 50-73, wherein the pan is a flat sheet and the single element further comprises sides that are physically connected to the pan.

Aspect 75 provides the apparatus of Aspect 74, wherein the sides comprise hollow cylindrical rods or hollow rectangular beams.

Aspect 76 provides the apparatus of Aspect 75, wherein the hollow rods or beams comprise one or more channels for flowing electrolyte therein.

Aspect 77 provides the apparatus of Aspect 76, wherein the hollow rods or beams comprise one or more openings or pass-throughs for manifolding electrolyte from adjacent rods or beams.

Aspect 78 provides the apparatus of Aspect 76, wherein the apparatus further comprises one or more external manifolds that distribute inlet electrolyte to the rods or beams and/or that combine outlet electrolyte streams.

Aspect 79 provides the apparatus of Aspect 74, wherein the sides comprise solid cylindrical rods or solid rectangular beams.

Aspect 80 provides the apparatus of any one of Aspects 50-79, further comprising one or more seals around a perimeter of the pan and current collector.

Aspect 81 provides the apparatus of any one of Aspects 50-80, wherein the single element has a thickness of 10 mm to 150 mm.

Aspect 82 provides the apparatus of any one of Aspects 50-81, wherein the single element has a thickness of 30 mm to 65 mm.

Aspect 83 provides a single element for a water electrolyzer stack, the single element comprising:
a pan;
a current collector parallel to the pan;
a gap between the pan and the current collector;
one or more electrically conductive connectors between the pan and the current collector that physically and connect the pan and the current collector;
an inlet that allows electrolyte to flow into the gap and into contact with an electrode adjacent to a face of the current collector that faces away from the pan; and
an outlet to allow electrolyte to flow out of the gap;
wherein the inlet and the outlet are independently located at one or more edges of the single element, and wherein the pan and the current collector together form a cavity therebetween.

Aspect 84 provides the single element of Aspect 83, wherein the single element is free of an electrode.

Aspect 85 provides the single element of any one of Aspects 83-84, wherein the single element comprises a cathode or an anode physically connected to the current collector. The single element can optionally further comprise an elastic element between the cathode or anode and the current collector.

Aspect 86 provides the single element of any one of Aspects 83-85, wherein the single element is free of additional current collectors that are physically connected to the pan.

Aspect 87 provides the single element of any one of Aspects 83-86, wherein the single element is free of additional current collectors.

Aspect 88 provides the single element of any one of Aspects 83-87, wherein the current collector is a first current collector, the one or more electrically conductive connectors are one or more first electrically conductive connectors, the inlet and outlet are a first inlet and a first outlet, the cavity is a first cavity, the gap is a first gap, and wherein on an opposite face of the pan the single element further comprises
a second current collector parallel to the pan;
a second gap between the second current collector and the pan;
one or more second electrically conductive connectors between the pan and the second current collector that physically connect the pan and the second current collector;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween,
or,
wherein the pan is electrically non-conductive, the current collector is a first current collector, the inlet and outlet are a first inlet and first outlet, the cavity is a first cavity, the gap is a first gap, the one or more electrically conductive connectors pass through the pan and physically connector the first current collector and a second current collector, and wherein on an opposite face of the pan the single element further comprises
the second current collector parallel to the pan;
a second gap between the second current collector and the pan;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

Aspect 89 provides the single element of Aspect 88, further comprising an anode adjacent to the first current collector and a cathode adjacent to the second current collector, or further comprising a cathode adjacent to the first current collector and an anode adjacent to the second current collector.

Aspect 90 provides the single element of any one of Aspects 83-89, wherein the conductive connector comprises a rib, a rib plate, or a combination thereof.

Aspect 91 provides the single element of any one of Aspects 83-90, wherein the conductive connector comprises a rib.

Aspect 92 provides the single element of any one of Aspects 83-91, wherein the pan comprises a flange that forms a seal with a flange on a pan of an adjacent single element.

Aspect 93 provides the single element of Aspect 92, wherein the flange is free of fastener holes.

Aspect 94 provides the single element of any one of Aspects 83-93, wherein the inlets of the single element are configured to sealingly align and fluidly connect with the inlets of another one of the single element adjacent thereto.

Aspect 95 provides the single element of any one of Aspects 83-94, wherein the outlets of the single element are configured to sealingly align and fluidly connect with the outlets of another one of the single element adjacent thereto.

Aspect 96 provides the single element of any one of Aspects 83-95, wherein the pan is a single continuous sheet with bent sides forming edges.

Aspect 97 provides the single element of Aspect 96, wherein the bent sides have a thickness identical to a thickness of a bottom of the pan.

Aspect 98 provides the single element of any one of Aspects 96-97, wherein the bent sides have a thickness that exceeds a thickness of a bottom of the pan.

Aspect 99 provides the single element of any one of Aspects 83-98, wherein the pan is a flat sheet and the single element further comprises sides that are physically connected to the pan.

Aspect 100 provides the single element of Aspect 99, wherein the sides comprise hollow cylindrical rods or hollow rectangular beams.

Aspect 101 provides the apparatus of Aspect 100, wherein the hollow rods or beams comprise one or more channels for flowing electrolyte therein.

Aspect 102 provides the apparatus of Aspect 101, wherein the hollow rods or beams comprise one or more openings or pass-throughs for manifolding electrolyte from adjacent rods or beams.

Aspect 103 provides the apparatus of Aspect 101, wherein the apparatus further comprises one or more external manifolds that distribute inlet electrolyte to the rods or beams and/or that combine outlet electrolyte streams.

Aspect 104 provides the single element of Aspect 99, wherein the sides comprise solid cylindrical rods or solid rectangular beams.

Aspect 105 provides the single element of any one of Aspects 66-84, further comprising one or more seals around a perimeter of the pan and current collector.

Aspect 106 provides the single element of any one of Aspects 66-85, wherein the single element has a thickness of 10 mm to 150 mm.

Aspect 107 provides the single element of any one of Aspects 66-86, wherein the single element has a thickness of 30 mm to 65 mm.

Aspect 108 provides an apparatus for water electrolysis, the apparatus comprising:
a stack comprising a stacked arrangement of two or more of the single elements of any one of Aspects 83-107 that are electrically connected in series.

Aspect 109 provides the apparatus of Aspect 108, wherein the stack comprises 2 to 200 of the single elements.

Aspect 110 provides the apparatus of Aspect 108, wherein the stack is a ministack, wherein the stack comprises 2 to 20 of the single elements.

Aspect 111 provides the apparatus of Aspect 110, wherein the stack comprises 3 to 10 of the single elements.

Aspect 112 provides a method of performing water electrolysis, the method comprising:
electrolyzing water using the apparatus of any one of Aspects 1-82 or 108-111.

Aspect 113 provides the method of claim 112, further comprising using an electrolyzer frame to provide compression to the apparatus sufficient to operate the cells at a pressure of 2 psig to 450 psig, or 2 psig to 100 psig.

Aspect 114 provides a method of performing alkaline water electrolysis, the method comprising:
electrolyzing water via alkaline water electrolysis using the apparatus of any one of Aspects 1-82 or 108-111.

Aspect 115 provides a method of performing anion exchange membrane water electrolysis, the method comprising:

electrolyzing water via anion exchange membrane water electrolysis using the apparatus of any one of Aspects 1-82 or 108-111.

Aspect 116 provides a method of manipulation and/or leak testing, the method comprising:
using tie rods and backing plates to provide sufficient compression of the apparatus of any one of Aspects 1-111 to operate the cell or cells at a pressure of 0.25 psig to 2 psig.

Aspect 117 provides the apparatus, method, or single element of any one or any combination of Aspects 1-116 optionally configured such that all elements or options recited are available to use or select from.

What is claimed is:

1. An apparatus for water electrolysis, the apparatus comprising:
two or more ministacks electrically connected in series and/or in parallel, each ministack comprising a stacked arrangement of 2 to 20 cells that are electrically connected in series, each cell comprising
an anode,
a cathode,
a separator between the anode and the cathode, and
a fluid flow system permitting anode electrolyte to be added to the cell, flowed in contact with the anode, and removed from the cell, and permitting cathode electrolyte to be added to the cell, flowed in contact with the cathode, and removed from the cell.

2. The apparatus of claim 1, wherein each ministack comprises 3 to 10 of the cells.

3. The apparatus of claim 1, wherein
the anode and the cathode independently comprise Ni, stainless steel, carbon, carbon steel, titanium, platinum, or a combination thereof, and/or
the anode and/or the cathode independently comprise an electrocatalyst comprising a platinum group metal, nickel, iron, cobalt, manganese, copper, or a combination thereof.

4. The apparatus of claim 1, wherein the ministack comprises a filter press, wherein the ministack comprises
one or more anode electrolyte channels between and within the cells of the ministack, and
one or more cathode electrolyte channels between and within the cells of the ministack.

5. The apparatus of claim 1, wherein the ministack comprises a stack of single elements, each single element comprising
a pan;
a current collector parallel to the pan;
a gap between the pan and the current collector;
one or more electrically conductive connectors between the pan and the current collector that physically connect the pan and the current collector;
an inlet that allows electrolyte to flow into the gap and into contact with an electrode adjacent to a face of the current collector that faces away from the pan; and
an outlet to allow electrolyte to flow out of the gap;
wherein the inlet and the outlet are independently located at one or more edges of the single element, and wherein the pan and the current collector together form a cavity therebetween.

6. The apparatus of claim 5, wherein the current collector is a first current collector, the one or more electrically conductive connectors are one or more first electrically conductive connectors, the inlet and outlet are a first inlet and a first outlet, the cavity is a first cavity, and the gap is a first gap, wherein on an opposite face of the pan the single element further comprises
a second current collector parallel to the pan;
a second gap between the second current collector and the pan;
one or more second electrically conductive connectors between the pan and the second current collector that physically connect the pan and the second current collector;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

7. The apparatus of claim 5, wherein the pan is electrically non-conductive, the current collector is a first current collector, the inlet and outlet are a first inlet and first outlet, the cavity is a first cavity, the gap is a first gap, the one or more electrically conductive connectors pass through the pan and physically connector the first current collector and a second current collector, and wherein on an opposite face of the pan the single element further comprises
the second current collector parallel to the pan;
a second gap between the second current collector and the pan;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

8. The apparatus of claim 5, wherein the pan a comprises a flange that forms a seal with a flange on a pan of an adjacent single element.

9. The apparatus of claim 5, wherein the inlets of adjacent single elements in the ministack sealingly align and fluidly connect with one another, and wherein the outlets of adjacent single elements in the ministack sealingly align and fluidly connect with one another.

10. The apparatus of claim 5, wherein the pan is a flat sheet and the single element further comprises sides that are physically connected to the pan.

11. The apparatus of claim 10, wherein the sides comprise hollow rods or beams that comprise electrolyte channels for flowing the electrolyte therethrough.

12. The apparatus of claim 5, wherein the single element has a thickness of 30 mm to 65 mm.

13. A single element for a water electrolyzer stack, the single element comprising:
a pan;
a current collector parallel to the pan;
a gap between the pan and the current collector;
one or more electrically conductive connectors between the pan and the current collector that physically connect the pan and the current collector;
an inlet that allows electrolyte to flow into the gap and into contact with an electrode adjacent to a face of the current collector that faces away from the pan; and
an outlet to allow electrolyte to flow out of the gap;
wherein the inlet and the outlet are independently located at one or more edges of the single element, and wherein the pan and the current collector together form a cavity therebetween.

14. The single element of claim 13, wherein the electrode is a cathode or an anode physically connected to the current collector.

15. The single element of claim 13, wherein the pan is electrically conductive, the current collector is a first current collector, the one or more electrically conductive connectors are one or more first electrically conductive connectors, the inlet and outlet are a first inlet and a first outlet, the cavity is a first cavity, the gap is a first gap, and wherein on an opposite face of the pan the single element further comprises
a second current collector parallel to the pan;
a second gap between the second current collector and the pan;
one or more second electrically conductive connectors between the pan and the second current collector that physically connect the pan and the second current collector;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

16. The single element of claim 13, wherein the pan is electrically non-conductive, the current collector is a first current collector, the inlet and outlet are a first inlet and first outlet, the cavity is a first cavity, the gap is a first gap, the one or more electrically conductive connectors pass through the pan and physically connector the first current collector and a second current collector, and wherein on an opposite face of the pan the single element further comprises
the second current collector parallel to the pan;
a second gap between the second current collector and the pan;
a second inlet that allows electrolyte to flow into the second gap and into contact with an electrode adjacent to a face of the second current collector that faces away from the pan; and
a second outlet that allows electrolyte to flow out of the second gap;
wherein the inlet and the outlet are independently located at one or more edges of the single element, and wherein the pan and the current collector together form a second cavity therebetween.

17. An apparatus for water electrolysis, the apparatus comprising:
a stack comprising a stacked arrangement of two or more of the single elements of claim 13 that are electrically connected in series.

18. A method of performing water electrolysis, the method comprising:
electrolyzing water using the apparatus of claim 1.

19. The method of claim 18, wherein sufficient compression to operate the cells is provided via use of an electrolyzer frame that compresses the cells.

20. A method of provides a method of leak testing, the method comprising:
using tie rods and backing plates to provide sufficient compression of the apparatus of claim 1 to operate the cells at a pressure of 0.25 psig to 2 psig.
